(19) United States
(12) Patent Application Publication
(10) Pub. No.: US 2018/0011702 A1
(43) Pub. Date: Jan. 11, 2018

(54) INFORMATION PROCESSING APPARATUS AND INFORMATION PROCESSING METHOD

(71) Applicant: FUJITSU LIMITED, Kawasaki-shi (JP)

(72) Inventor: Yoshiyuki TAKAMASA, Kawasaki (JP)

(73) Assignee: FUJITSU LIMITED, Kawasaki-shi (JP)

(21) Appl. No.: 15/636,783

(22) Filed: Jun. 29, 2017

(30) Foreign Application Priority Data
Jul. 8, 2016 (JP) 2016-136392

(51) Int. Cl. G06F 9/445; G06F 11/14; G06F 11/16; G06F 11/20

(52) U.S. Cl. CPC G06F 8/65; G06F 11/1666; G06F 11/1433; G06F 11/2089; G06F 11/20

(57) ABSTRACT

An information processing apparatus includes a memory; and a processor coupled to the memory and the processor configured to: generate first information including configuration information and/or interface information of a first program of an old version based on code of the first program of the old version, and generate second information including configuration information and/or interface information of the first program of a new version based on code of the first program of the new version; and generate information on compatibility between the first program of the old version and the first program of the new version based on whether there is a difference between the first information and the second information generated by the processor.

### CROSS-REFERENCE TO RELATED APPLICATION

This application is based upon and claims the benefit of priority of the prior Japanese Patent Application No. 2016-136392, filed on Jul. 8, 2016, the entire contents of which are incorporated herein by reference.

### FIELD

The embodiments discussed herein are related to an information processing apparatus and an information processing method using a program management technique.

### BACKGROUND

On-line update may be executed to add or modify a function of a firmware installed in a server. The on-line update is to update a program such as a firmware in a server based on data acquired via a network such as the Internet while keeping the server in operation.

However, if an old version firmware and a new version firmware are incompatible with each other, a server may hang up in execution of the new version firmware, for example. Also, a failure may occur in communications between an updated firmware and another firmware. In this way, the update of a firmware fails when a problem occurs during the update. However, a technique of determining the compatibility between an old version firmware and a new version firmware has not been disclosed in related techniques.

Related techniques are disclosed in, for example, Japanese Laid-open Patent Publication Nos. 2011-145910, 2012-146329, and 2012-190199.

### SUMMARY

According to an aspect of the embodiments, an information processing apparatus includes a memory; and a processor coupled to the memory and the processor configured to: generate first information including configuration information and/or interface information of a first program of an old version based on code of the first program of the old version, and generate second information including configuration information and/or interface information of the first program of a new version based on code of the first program of the new version; and generate information on compatibility between the first program of the old version and the first program of the new version based on whether there is a difference between the first information and the second information generated by the processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a schematic view of a system according to this embodiment;

FIG. 2 is a functional block diagram of an information processing apparatus;

FIG. 3 is a diagram for illustrating generation of an integrated firmware;

FIG. 4 illustrates an example of the integrated firmware;

FIG. 5 illustrates a process flow of processing executed by a compile section;

FIG. 6A illustrates an example of code of a firmware in a first embodiment;

FIG. 6B illustrates an example of code of a firmware in the first embodiment;

FIG. 6C illustrates an example of code of a firmware in the first embodiment;

FIG. 6D illustrates an example of code of a firmware in the first embodiment;

FIG. 7A illustrates an example of management data of a firmware configuration in the first embodiment;

FIG. 7B illustrates an example of management data of a firmware configuration in the first embodiment;

FIG. 7C illustrates an example of management data of a firmware interface in the first embodiment;

FIG. 7D illustrates an example of a firmware interface in the first embodiment;

FIG. 8 is a diagram illustrating a process flow of processing executed by a first management section in the first embodiment;

FIG. 9 illustrates an example of compatibility data;

FIG. 10 is a diagram illustrating a process flow of processing executed by the first management section in the first embodiment;

FIG. 11 is a diagram illustrating a process flow of processing executed by a second management section in the first embodiment;

FIG. 12 illustrates an example of compatibility data;

FIG. 13 is a diagram illustrating a process flow of processing executed by the second management section in the first embodiment;

FIG. 14 is a diagram illustrating a process flow of processing executed by a third management section;

FIG. 15 illustrates an example of compatibility data;

FIG. 16A is a diagram illustrating a process flow of processing executed by the third management section;

FIG. 16B is a diagram illustrating a process flow of processing executed by an integration section;

FIG. 17A illustrates an example of configuration information of a firmware in a second embodiment;

FIG. 17B illustrates an example of configuration information of a firmware in the second embodiment;

FIG. 17C illustrates an example of configuration information of a firmware in the second embodiment;

FIG. 17D illustrates an example of configuration information of a firmware in the second embodiment;

FIG. 18A illustrates an example of management data in the second embodiment;

FIG. 18B illustrates an example of management data in the second embodiment;

FIG. 19 is a diagram illustrating a process flow of processing executed by the first management section in the second embodiment;

FIG. 20 is a diagram illustrating a process flow of processing executed by the first management section in the second embodiment;

FIG. 21A illustrates a specific example of detection of a difference between configuration information;

FIG. 21B illustrates a specific example of detection of a difference between configuration information;

FIG. 21C illustrates a specific example of detection of a difference between configuration information;

FIG. 22A illustrates a specific example of detection of a difference between configuration information;

FIG. 22B illustrates a specific example of detection of a difference between configuration information;

FIG. 22C illustrates a specific example of detection of a difference between configuration information;

FIG. 23A illustrates a specific example of detection of a difference between configuration information;

FIG. 23B illustrates a specific example of detection of a difference between configuration information;

FIG. 23C illustrates a specific example of detection of a difference between configuration information;

FIG. 24A illustrates a specific example of detection of a difference between configuration information;

FIG. 24B illustrates a specific example of detection of a difference between configuration information;

FIG. 24C illustrates a specific example of detection of a difference between configuration information;

FIG. 25A is a diagram illustrating an example of an interface of a firmware in a third embodiment;

FIG. 25B is a diagram illustrating an example of an interface of a firmware in the third embodiment;

FIG. 26A is a diagram illustrating an example of an interface of a firmware in the third embodiment;

FIG. 26B is a diagram illustrating an example of an interface of a firmware in the third embodiment;

FIG. 27 is a diagram illustrating an example of an interface of a firmware in the third embodiment;

FIG. 28A is a diagram illustrating an example of management data in third embodiment;

FIG. 28B is a diagram illustrating an example of management data in the third embodiment;

FIG. 28C is a diagram illustrating an example of management data in the third embodiment;

FIG. 29 is a diagram illustrating a process flow of processing executed by a second management section in the third embodiment;

FIG. 30 is a diagram illustrating a process flow of processing executed by the second management section in the third embodiment;

FIG. 31A is a diagram illustrating a specific example of detection of a difference between interfaces;

FIG. 31B is a diagram illustrating a specific example of detection of a difference between interfaces;

FIG. 31C is a diagram illustrating a specific example of detection of a difference between interfaces;

FIG. 32A is a diagram illustrating a specific example of detection of a difference between interfaces;

FIG. 32B is a diagram illustrating a specific example of detection of a difference between interfaces;

FIG. 32C is a diagram illustrating a specific example of detection of a difference between interfaces;

FIG. 33A is a diagram illustrating a specific example of detection of a difference between interfaces;

FIG. 33B is a diagram illustrating a specific example of detection of a difference between interfaces;

FIG. 33C is a diagram illustrating a specific example of detection of a difference between interfaces;

FIG. 34A is a diagram illustrating a specific example of detection of a difference between interfaces;

FIG. 34B is a diagram illustrating a specific example of detection of a difference between interfaces;

FIG. 34C is a diagram illustrating a specific example of detection of a difference between interfaces; and

FIG. 35 is a functional block diagram of a computer.

### DESCRIPTION OF EMBODIMENTS

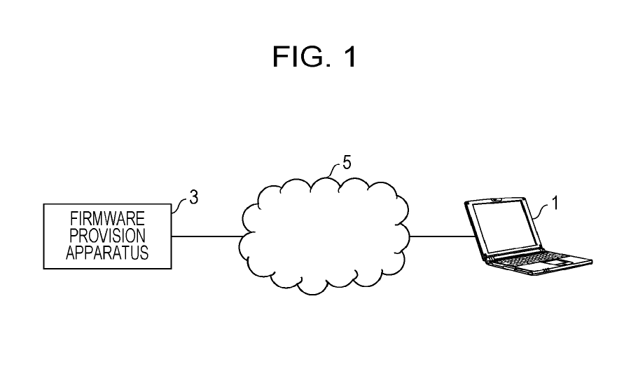

FIG. 1 illustrates a schematic overview of a system according to this embodiment. An information processing apparatus 1 to execute main processing of this embodiment is coupled to a network 5 such as, for example, the Internet. The network 5 is coupled to a firmware provision apparatus 3. The information processing apparatus 1 is configured to receive a firmware provided by the firmware provision apparatus 3 via the network 5, and update (for example, on-line update) a firmware in the information processing apparatus 1 with the received firmware.

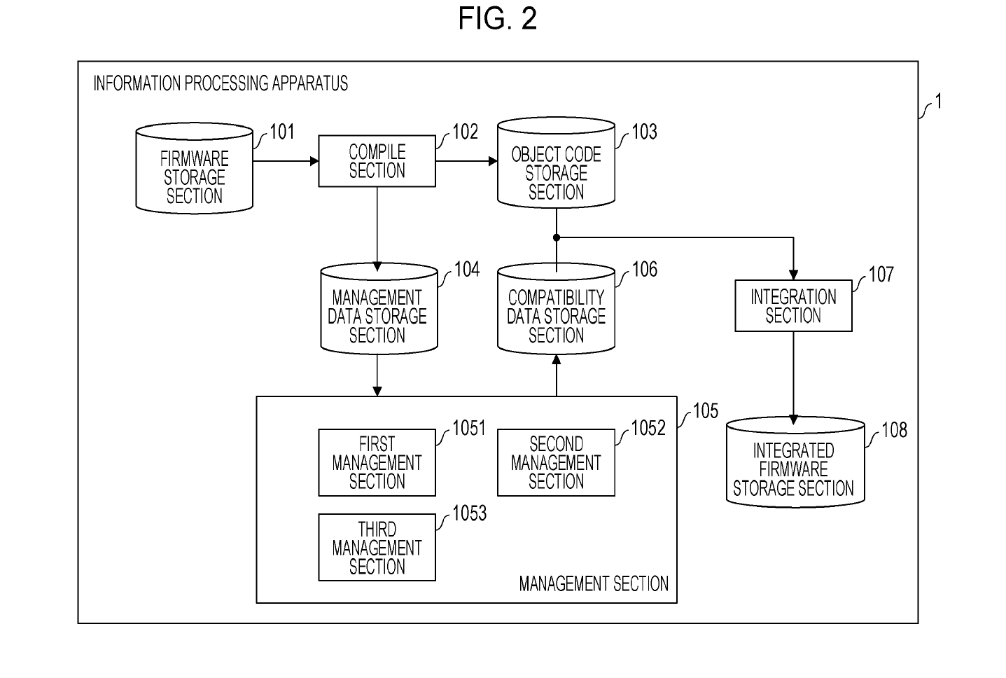

FIG. 2 illustrates a functional block diagram of the information processing apparatus 1. The information processing apparatus 1 includes a firmware storage section 101, a compile section 102, an object code storage section 103, a management data storage section 104, a management section 105, a compatibility data storage section 106, an integration section 107, and an integrated firmware storage section 108. The management section 105 includes a first management section 1051, a second management section 1052, and a third management section 1053.

The firmware storage section 101 stores a firmware that the information processing apparatus 1 receives from the firmware provision apparatus 3. In this embodiment, a basic input output system (BIOS) firmware, a maintenance management board (MMB) firmware, and a baseboard management controller (BMC) firmware are received from the firmware provision apparatus 3 when adding and/or modifying a function of a firmware.

The compile section 102 compiles a firmware stored in the firmware storage section 101 and thereby generates object code and management data. The compile section 102 stores the generated object code into the object code storage section 103 and the generated management data into the management data storage section 104. As the code of the firmware includes code for generating the management data, the management data is generated by compiling the code of the firmware. The code for generating the management data may be added by an administrator of the information processing apparatus 1 to the code of the firmware received by the information processing apparatus 1, or may be included in the code of the firmware provided by the firmware provision apparatus 3.

The management section 105 executes processing of determining compatibility between firmwares based on data stored in the management data storage section 104. Specifically, the first management section 1051 executes the processing of determining the compatibility based on a configuration of an old version firmware and a configuration of a new version firmware. The second management section 1052 executes the processing of determining the compatibility based on an interface of an old version firmware and an interface of a new version firmware. The new version firmware may include a firmware that is simply updated by adding and/or modifying at least one function. The third management section 1053 executes the processing of determining the compatibility based on an interface of a certain firmware and an interface of another firmware included in one and the same integrated firmware.

The configuration of the firmware is, for example, a data format of the firmware. The interface of the firmware is, for example, a format of a command for firmware-to-firmware communications.

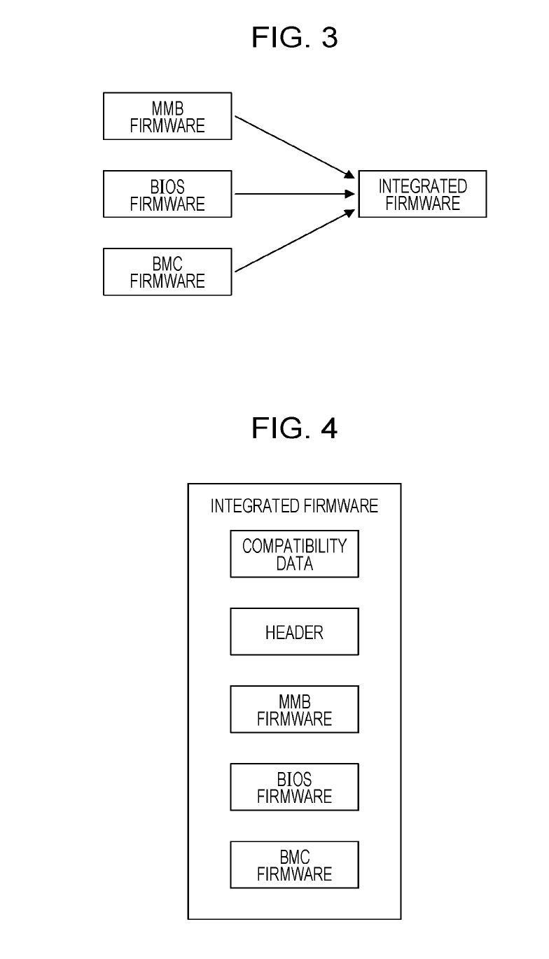

The integration section 107 generates an integrated firmware based on object code stored in the object code storage section 103 and compatibility data stored in the compatibility data storage section 106, and stores the generated integrated firmware into the integrated firmware storage section 108. In this embodiment, an integrated firmware including the MMB firmware, the BIOS firmware, and the BMC firmware is generated as illustrated in FIG. 3. More particularly, as illustrated in FIG. 4, the integrated firmware includes compatibility data, a header including information of a list of firmwares included in the integrated firmware, the MMB firmware, the BIOS firmware, and the BMC firmware.

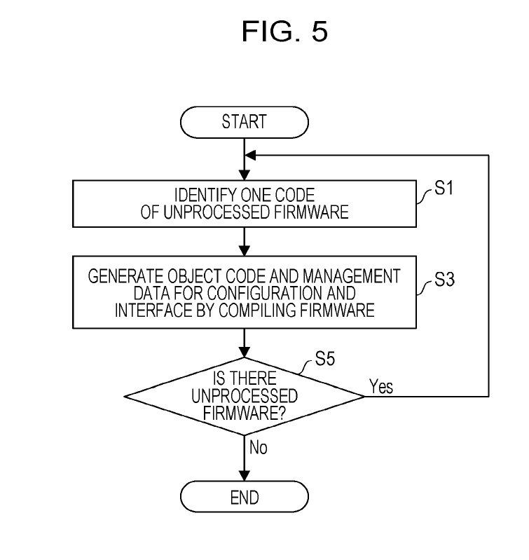

Next, an operation of the information processing apparatus 1 is described with reference to FIGS. 5 to 7D.

First, processing of generating management data from a firmware is described with reference to FIG. 5.

The compile section 102 reads the code of an unprocessed firmware from the firmware storage section 101 (step S1 of FIG. 5). For example, when the BMC firmware and the MMB firmware are unprocessed, the code of any one of the firmwares is read.

The compile section 102 compiles the code of the firmware read in step S1 and thereby generates the object code and management data for the configuration and interface (step S3). The compile section 102 stores the generated object code into the object code storage section 103 and the generated management data into the management data storage section 104.

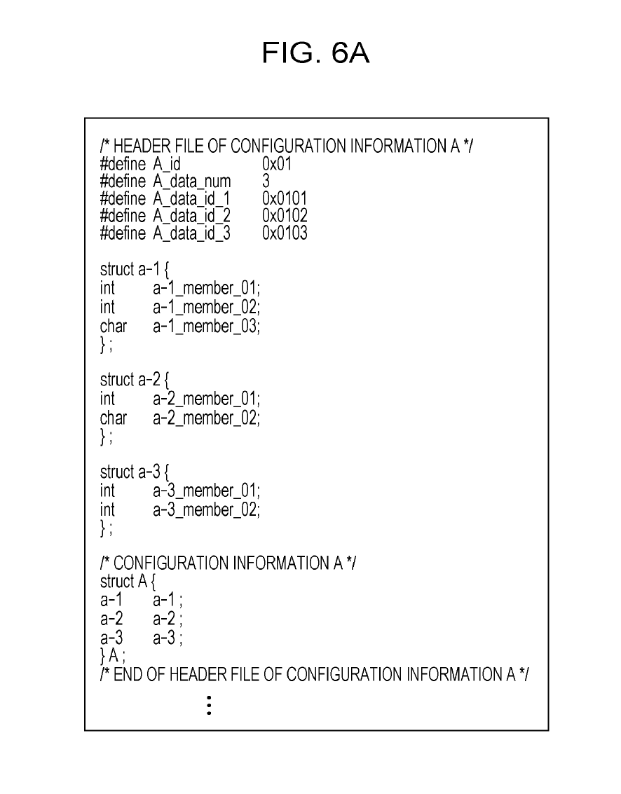

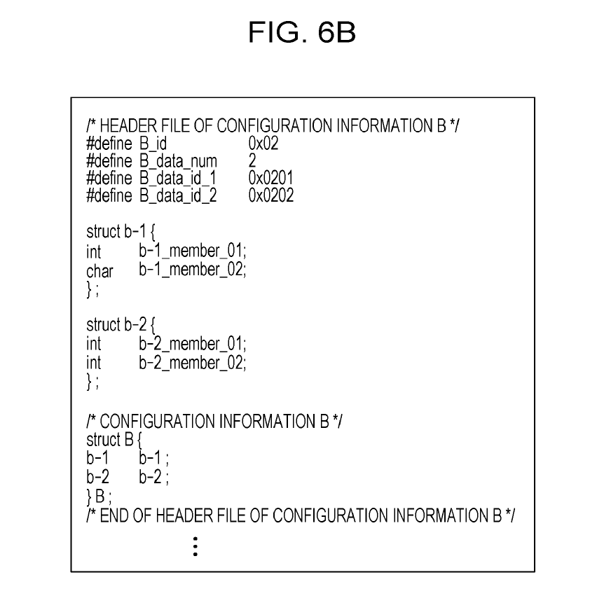

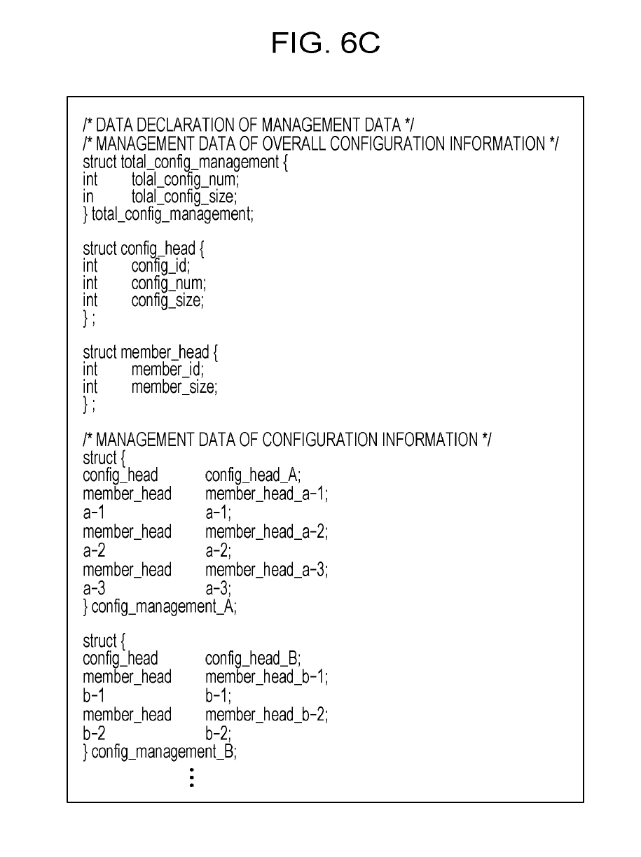

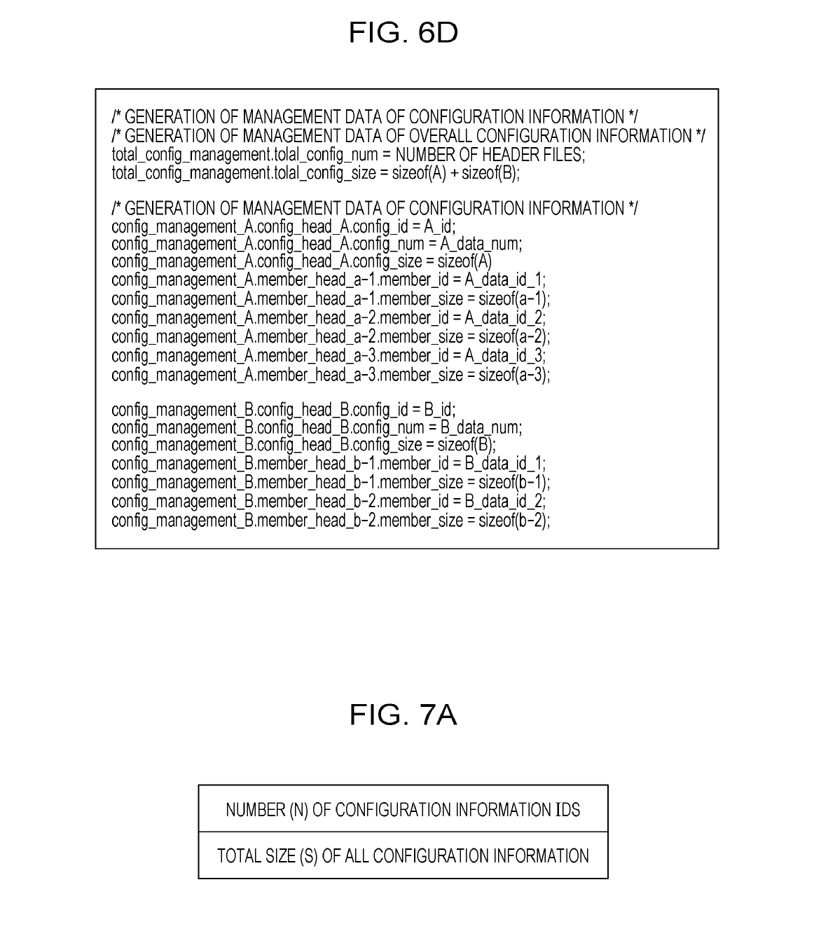

FIGS. 6A to 6D illustrate examples of the code of the firmware. The configuration information of the firmware is written in the C language in FIGS. 6A and 6B, and the management data of the configuration information is written in the C language in FIGS. 6C and 6D. The header file is provided in each piece of configuration information. Thus, the number of configuration information identifiers (IDs) may be calculated by counting the header files when compiling. The configuration information may include information of a data format of the firmware.

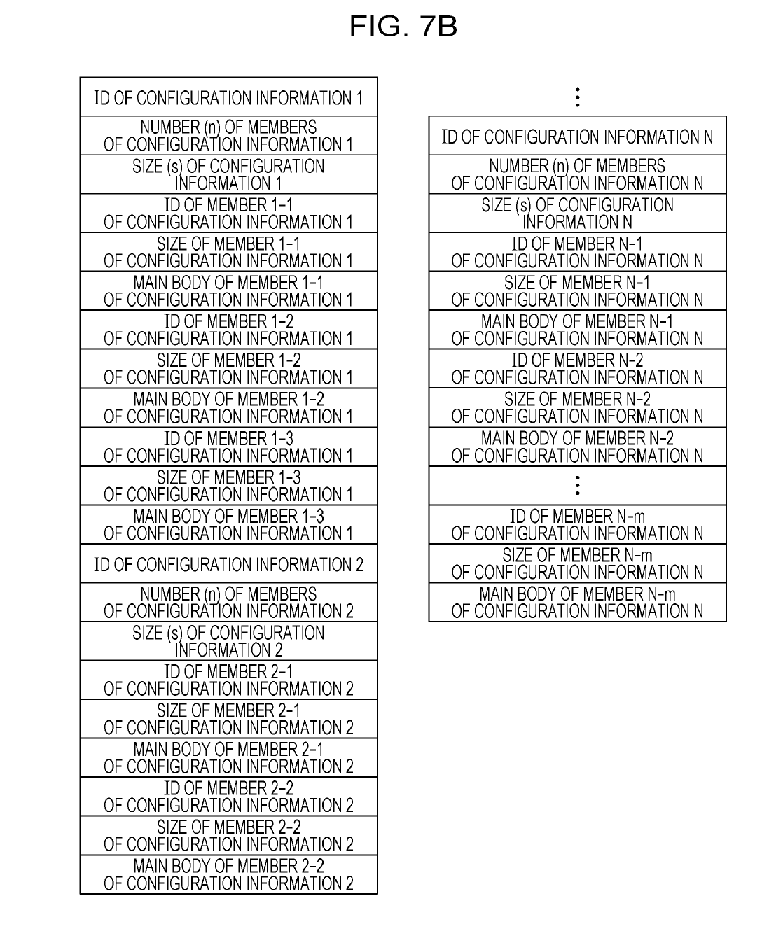

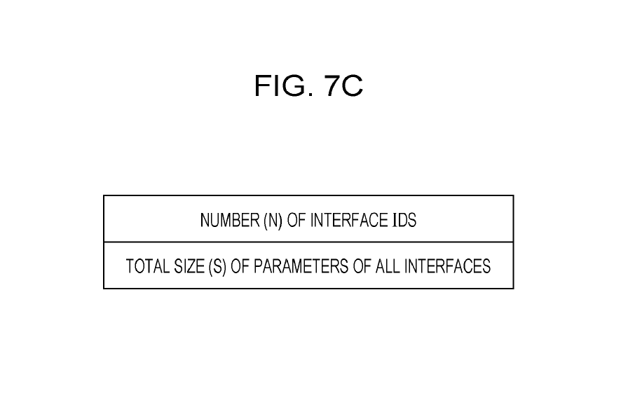

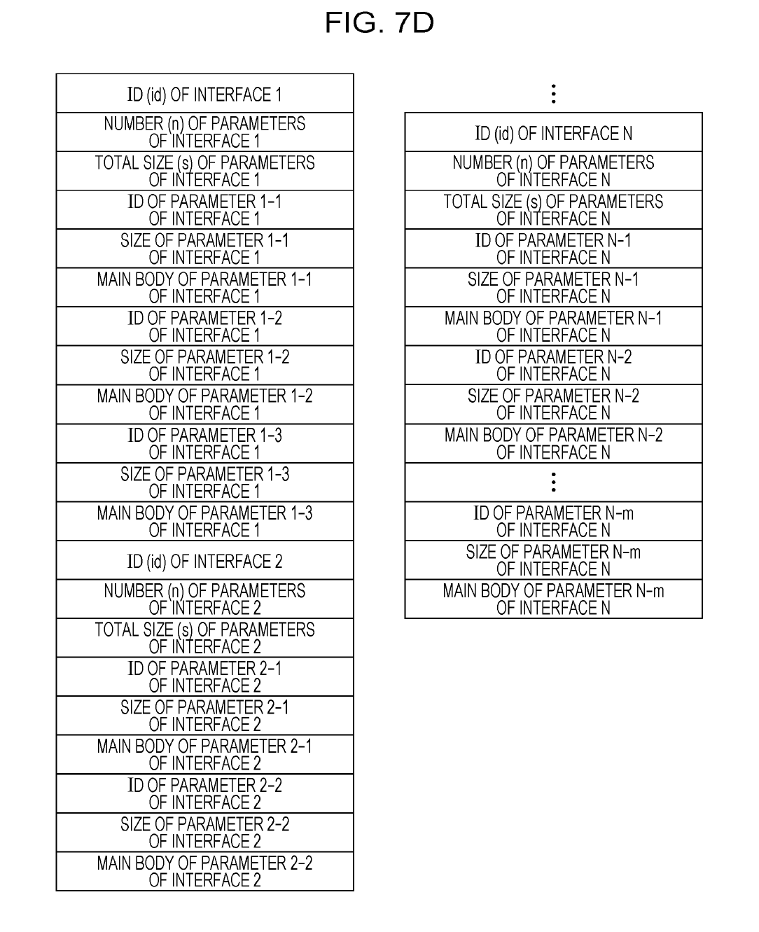

FIGS. 7A to 7D illustrate examples of the management data. FIGS. 7A and 7B are diagrams illustrating the examples of the management data of the configuration of the firmware, and FIGS. 7C and 7D are diagrams illustrating the examples of the management data of interfaces of the firmware.

As illustrated in FIGS. 7A and 7B, the management data of the configuration of the firmware includes the number of configuration information IDs and the total size of all configuration information. For each configuration information ID, the management data includes the number of members of the configuration information, the size of the configuration information, the ID of each member, the size of each member, and the main body of each member. In this example, the number of the configuration information ID is N (N is a natural number), and the total size of all configuration information is the sum of the sizes of configuration information 1 to N.

As illustrated in FIGS. 7C and 7D, the management data of the interfaces of the firmware includes the number of interface IDs and the total size of parameters of all the interfaces. For each interface ID, the management data includes the number of parameters of the interface, the total size of the parameters, the ID of each parameter, the size of each parameter, and the main body of each parameter.

Returning to FIG. 5, the compile section 102 determines whether there is an unprocessed firmware (step S5). When there is an unprocessed firmware (step S5: Yes), the processing returns to step S1. On the other hand, when there is no unprocessed firmware (step S5: No), the processing is terminated.

If the management data is generated in building of binary data as described above, the management data may be used in later processing.

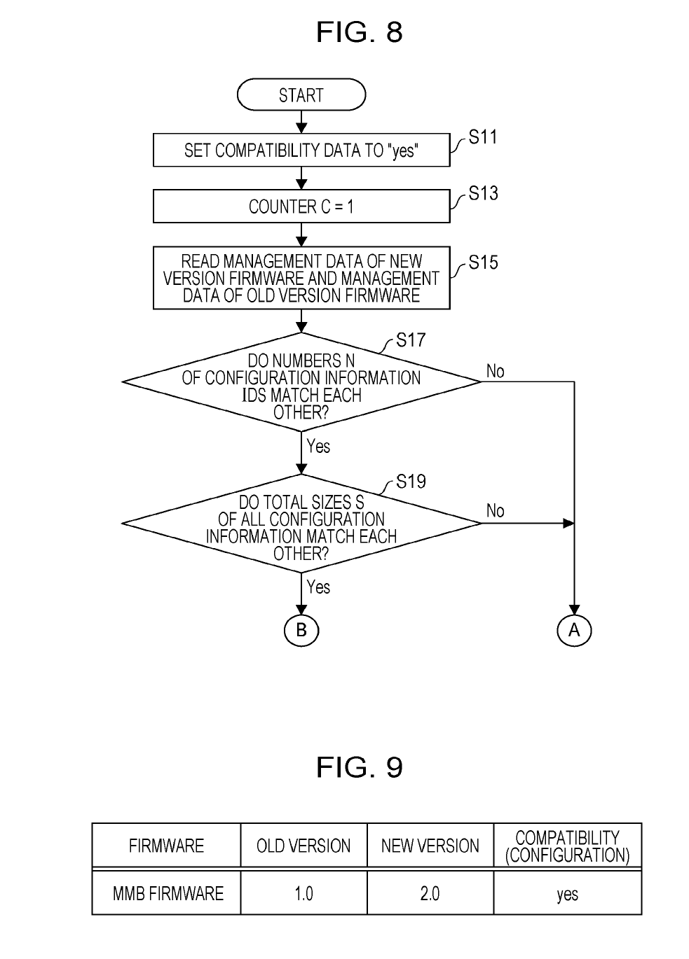

Next, processing executed by the first management section 1051 is described with reference to FIGS. 8 to 10. In the description below, a firmware to be processed is referred to as a target firmware.

The first management section 1051 sets compatibility data of the configuration of the target firmware stored in the compatibility data storage section 106 to “Yes” (step S11 of FIG. 8). The processing in step S11 is equivalent to initialization.

FIG. 9 illustrates an example of compatibility data of an old version configuration and a new version configuration. In the example of FIG. 9, the name of a firmware, an identification number of the old version, an identification number of the new version, and data indicating compatibility between the configurations are stored. Here, “yes” indicates compatible, and “no” indicates incompatible.

The first management section 1051 sets a counter C indicating the configuration information ID to C=1 (step S13).

For a target firmware, the first management section 1051 reads the management data of the new version firmware and the management data of the old version firmware from the management data storage section 104 (step S15).

The first management section 1051 determines whether the number of configuration information IDs of the new version firmware and the number of configuration information IDs of the old version firmware match each other (step S17). Here, the number of configuration information IDs is denoted by N.

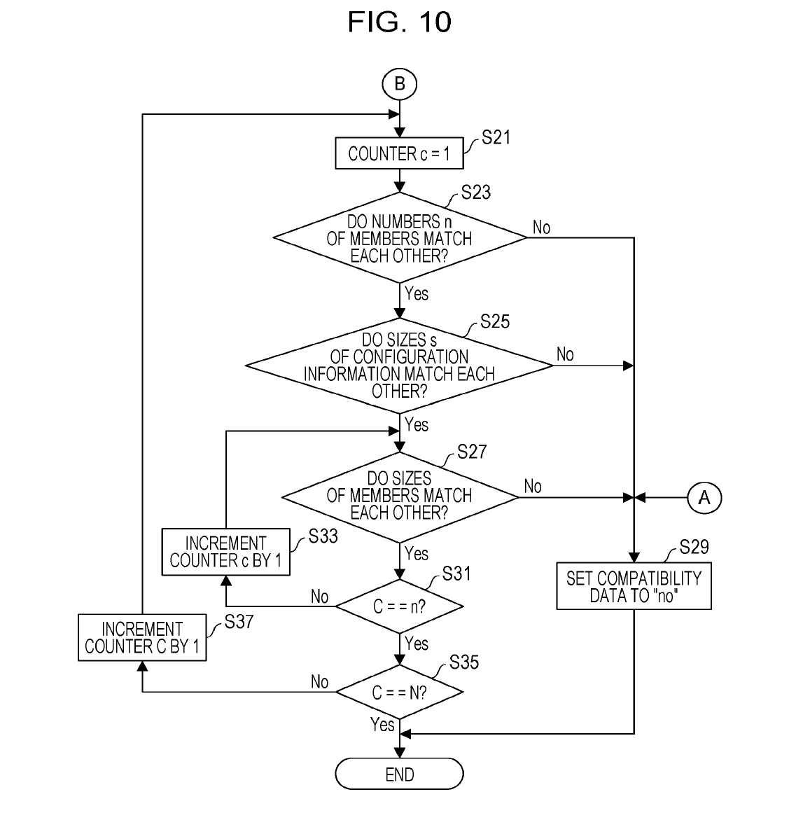

When the number N of configuration information IDs of the new version firmware and the number N of configuration information IDs of the old version firmware do not match each other (step S17: No), the new version firmware and the old version firmware are incompatible with each other (in other words, a failure may occur if on-line update from the old version to the new version is performed). Therefore, the processing is advanced to step S29 of FIG. 10 via a terminal A.

On the other hand, when the number N of configuration information IDs of the new version firmware and the number N of configuration information IDs of the old version firmware match each other (step S17: Yes), the first management section 1051 determines whether the total size of all configuration information of the new version firmware and the total size of all configuration information of the old version firmware match each other (step S19). Here, the total size of all configuration information is denoted by S.

When the total size S of all configuration information of the new version firmware and the total size S of all configuration information of the old version firmware do not match each other (step S19: No), the new version firmware and the old version firmware are incompatible with each other (in other words, a failure may occur if on-line update from the old version to the new version is performed). Therefore, the processing is advanced to step S29 of FIG. 10 via the terminal A.

On the other hand, when the total size S of all configuration information of the new version firmware and the total size S of all configuration information of the old version firmware match each other (step S19: Yes), the processing is advanced to step S21 of FIG. 10 via a terminal B.

Referring to FIG. 10, the first management section 1051 sets a counter c indicating a member to c=1 (step S21 of FIG. 10).

The first management section 1051 determines whether the number of new version members and the number of old version members match each other for the configuration information indicated by the counter C (for example, configuration information 1 when the value of the counter C is 1) (step S23). Here, the number of members is denoted by n.

When the number n of new version members and the number n of old version members do not match each other (step S23: No), the new version firmware and the old version firmware are incompatible with each other (in other words, a failure may occur if on-line update from the old version to the new version is performed). Thus, the processing is advanced to step S29.

On the other hand, when the number n of new version members and the number n of old version members match each other (step S23: Yes), the first management section 1051 determines whether the size of the new version configuration information and the size of the old version configuration information match each other for the configuration information indicated by the counter C (step S25). Here, the size of configuration information is denoted by s.

When the size s of the new version configuration information and the size s of the old version configuration information do not match each other (step S25: No), the new version firmware and the old version firmware are incompatible with each other (in other words, a failure may occur if on-line update from the old version to the new version is performed). Thus, the processing is advanced to step S29.

When the size s of the new version configuration information and the size s of the old version configuration information match each other (step S25: Yes), the first management section 1051 determines whether the size of the old version member indicated by the counter c and the size of the new version member indicated by the counter c match each other for the configuration information indicated by the counter C (step S27).

When the size of the old version member indicated by the counter c and the size of the new version member indicated by the counter c do not match each other for the configuration information indicated by the counter C (step S27: No), the first management section 1051 sets the compatibility data of the configuration of the target firmware stored in the compatibility data storage section 106 to “no” (step S29). Then, the processing is terminated.

On the other hand, when the size of the old version member indicated by the counter c and the size of the new version member indicated by the counter c match each other for the configuration information indicated by the counter C (step S27: Yes), the first management section 1051 determines whether c==n holds (that is, c is equal to n) (step S31).

When c==n does not hold (step S31: No), the first management section 1051 increments the value of the counter c by 1 (step S33). Then, the processing returns to step S27.

On the other hand, when c==n holds (step S31: Yes), the first management section 1051 determines whether C==N holds (that is, C is equal to N) (step S35).

When C==N does not hold (step S35: No), the first management section 1051 increments the counter C by 1 (step S37). Then, the processing returns to step S21. On the other hand, when C==N holds (step S35: Yes), the processing is terminated.

Thus, when the configuration of the new version firmware and the configuration of the old version firmware do not match each other, the compatibility data indicating configuration incompatibility is generated as described above.

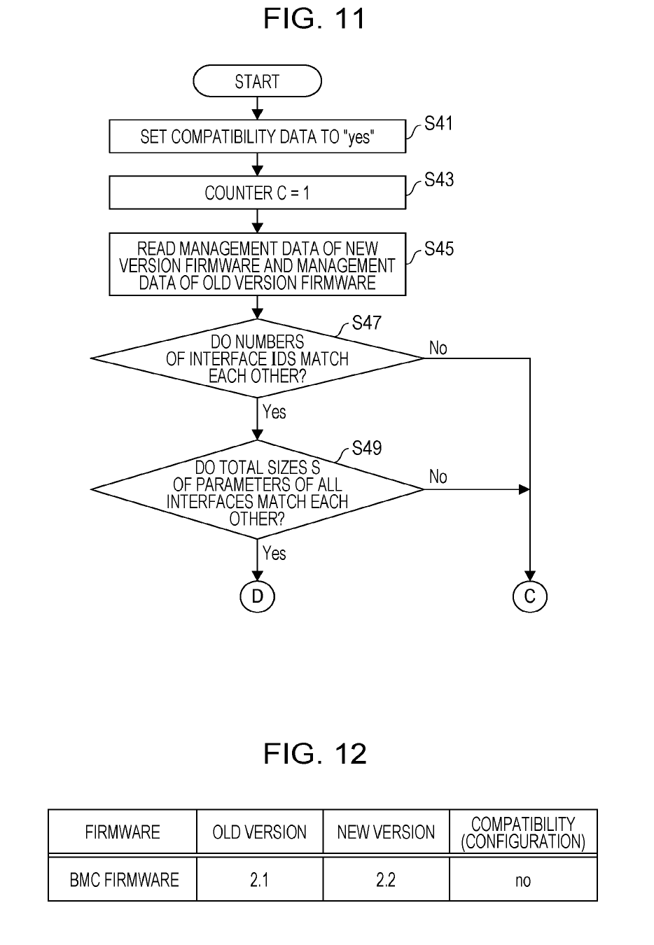

Next, processing executed by the second management section 1052 is described with reference to FIGS. 11 to 13. In the description below, a firmware to be processed is referred to as a target firmware.

The second management section 1052 sets the compatibility data of an interface of the target firmware stored in the compatibility data storage section 106 to “yes” (step S41 of FIG. 11). The processing of step S41 is equivalent to initialization.

FIG. 12 illustrates an example of compatibility data of an old version interface and a new version interface. In the example of FIG. 12, the name of a firmware, an identification number of the old version, an identification number of the new version, and data indicating compatibility between the interfaces are stored. Here, “yes” indicates compatible, and “no” indicates incompatible.

The second management section 1052 sets a counter C indicating the interface ID to C=1 (step S43).

For the target firmware, the second management section 1052 reads the management data of the new version firmware and the management data of the old version firmware from the management data storage section 104 (step S45).

The second management section 1052 determines whether the number of interface IDs of the new version firmware and the number of interface IDs of the old version firmware match each other (step S47). Here, the number of interface IDs is denoted by N.

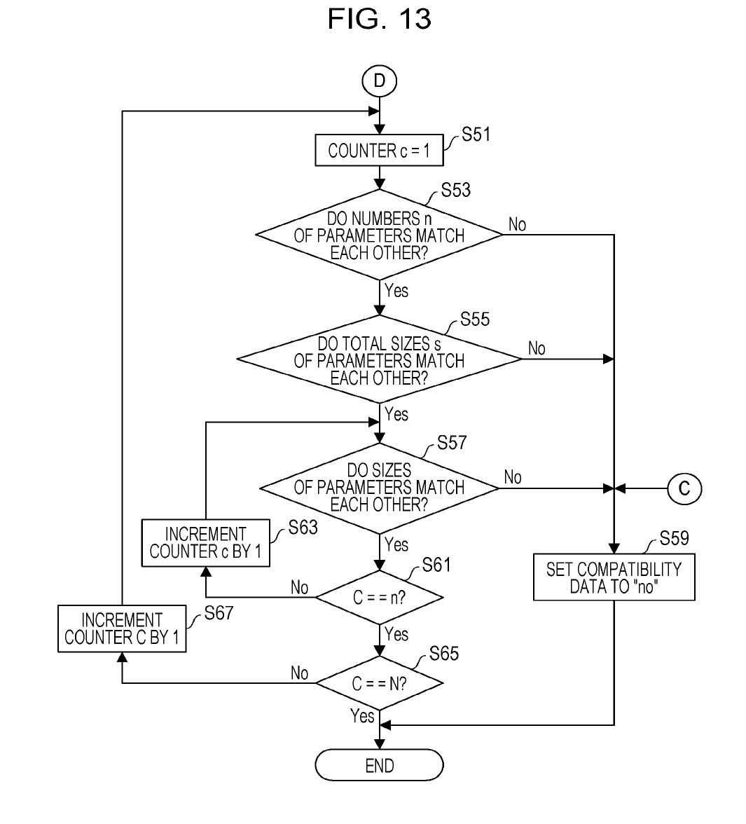

When the number N of interface IDs of the new version firmware and the number N of interface IDs of the old version firmware do not match each other (step S47: No), the new version firmware and the old version firmware are incompatible with each other (in other words, a failure may occur if on-line update from the old version to the new version is performed). Thus, the processing is advanced to step S59 of FIG. 13 via a terminal C.

On the other hand, when the number N of interface IDs of the new version firmware and the number N of interface IDs of the old version firmware match each other (step S47: Yes), the second management section 1052 determines whether the total size of parameters of all interfaces of the new version firmware and the total size of parameters of all interfaces of the old version firmware match each other (step S49). Here, the total size of parameters of all interfaces is denoted by S.

When the total size S of parameters of all interfaces of the new version firmware and the total size S of parameters of all interfaces of the old version firmware do not match each other (step S49: No), the new version firmware and the old version firmware are incompatible with each other (in other words, a failure may occur if on-line update from the old version to the new version is performed). Thus, the processing is advanced to step S59 of FIG. 13 via the terminal C.

On the other hand, when the total size S of parameters of all interfaces of the new version firmware and the total size S of parameters of all interfaces of the old version firmware match each other (step S49: Yes), the processing is advanced to step S51 of FIG. 13 via a terminal D.

Referring to FIG. 13, the second management section 1052 sets a counter c indicating a parameter to c=1 (step S51 of FIG. 13).

The second management section 1052 determines whether the number n of new version parameters and the number n of old version parameters match each other for the interface indicated by the counter C (for example, an interface 1 when the value of the counter C is 1) (step S53). Here, the number of parameters is denoted by n.

When the number n of new version parameters and the number n of old version parameters do not match each other (step S53: No), the new version firmware and the old version firmware are incompatible with each other (in other words, a failure may occur if on-line update from the old version to the new version is performed). Thus, the processing is advanced to step S59.

On the other hand, when the number n of new version parameters and the number n of old version parameters match each other (step S53: Yes), the second management section 1052 determines whether the total size of new version parameters and the total size of old version parameters match each other for the interface indicated by the counter C (step S55). Here, the total size of parameters is denoted by s.

When the total size s of new version parameters and the total size s of old version parameters do not match each other (step S55: No), the new version firmware and the old version firmware are incompatible with each other (in other words, a failure may occur if on-line update from the old version to the new version is performed). Thus, the processing is advanced to step S59.

On the other hand, when the total size s of new version parameters and the total size s of old version parameters match each other (step S55: Yes), the second management section 1052 determines whether the size of the old version parameter indicated by the counter c and the size of the new version parameter indicated by the counter c match each other for the interface indicated by the counter C (step S57). In step S57, it is determined that there is a difference when the size of at least one parameter is different between the old and new versions.

When the size of the old version parameter indicated by the counter c and the size of the new version parameter indicated by the counter c do not match each other for the interface indicated by the counter C (step S57: No), the second management section 1052 sets the compatibility data of the interface of the target firmware stored in the compatibility data storage section 106 to “no” (step S59). Then, the processing is terminated.

On the other hand, when the size of the old version parameter indicated by the counter c and the size of the new version parameter indicated by the counter c match each other for the interface indicated by the counter C (step S57: Yes), the second management section 1052 determines whether c==n holds (that is, c is equal to n) (step S61).

When c==n does not hold (step S61: No), the second management section 1052 increments the value of the counter c by 1 (step S63). Then, the processing returns to step S57.

On the other hand, when c==n holds (step S61: Yes), the second management section 1052 determines whether C==N holds (that is, C is equal to N) (step S65).

When C==N does not hold (step S65: No), the second management section 1052 increments the counter C by 1 (step S67). Then, the processing returns to step S51. On the other hand, when C==N holds (step S65: Yes), the processing is terminated.

As above, when the interface of the new-version firmware and the interface of the old-version firmware do not match each other, compatibility data indicating interface incompatibility is generated.

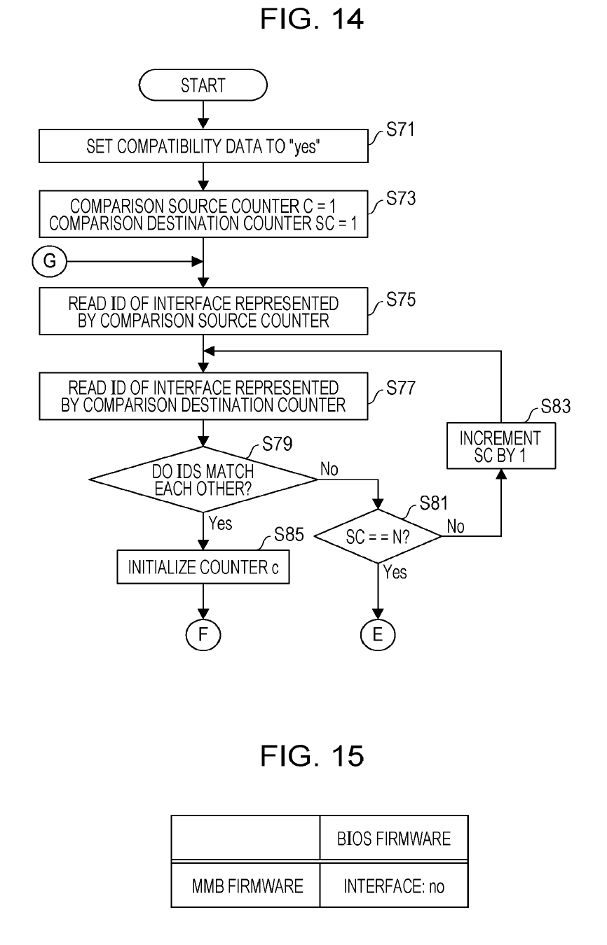

Next, processing executed by the third management section 1053 is described with reference to FIGS. 14 to 16A. The third management section 1053 executes processing of determining the compatibility between an interface of a firmware and an interface of another firmware included in the same integrated firmware. More specifically, it is determined whether firmware communication between firmwares included in the same integrated firmware will be performed without a problem after on-line update.

The third management section 1053 sets the compatibility data stored in the compatibility data storage section 106 and indicating interface compatibility for the combination with target firmwares to “yes” (step S71 of FIG. 14). The processing of step S71 is equivalent to initialization.

FIG. 15 illustrates an example of compatibility data for an interface between firmwares included in the same integrated firmware. In the example of FIG. 15, data indicating compatibility between the interfaces is stored for a pair of firmwares. Here, “yes” indicates compatible, and “no” indicates incompatible.

The third management section 1053 sets a comparison source counter C indicating a comparison source interface to C=1, and sets a comparison destination counter SC indicating a comparison destination interface to SC=1 (step S73).

The third management section 1053 identifies the ID of the interface (hereinafter referred to as a comparison source interface) indicated by the comparison source counter C from the management data storage section 104 (step S75).

The third management section 1053 identifies the ID of the interface (hereinafter referred to as a comparison destination interface) indicated by the comparison destination counter SC from the management data storage section 104 (step S77).

The third management section 1053 determines whether the ID of the comparison source interface and the ID of the comparison destination interface match each other (step S79).

When the ID of the comparison source interface and the ID of the comparison destination interface do not match each other (step S79: No), the third management section 1053 determines whether SC==N holds (step S81). Here, N denotes the number of interface IDs.

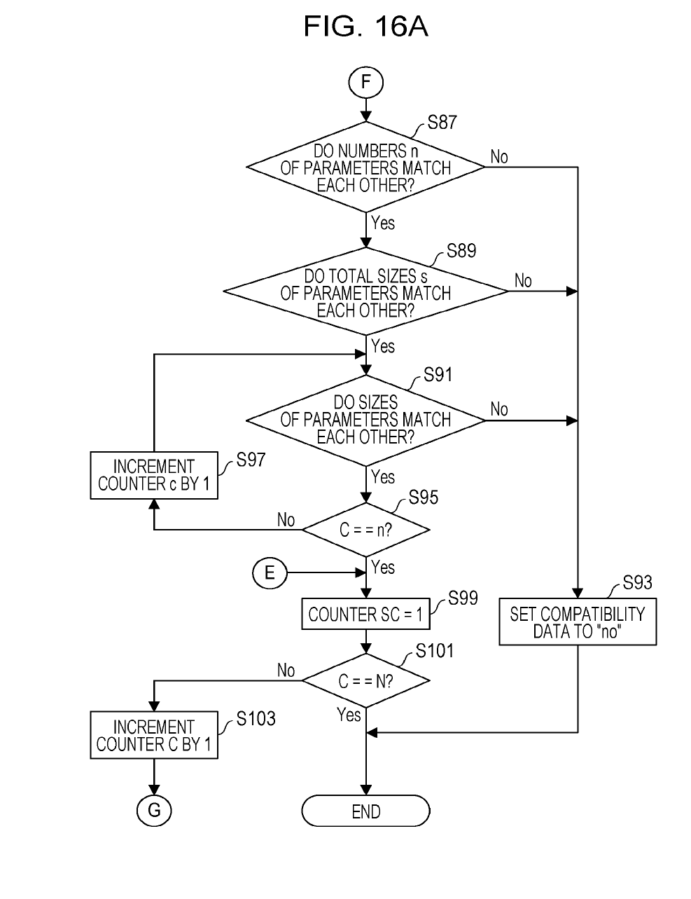

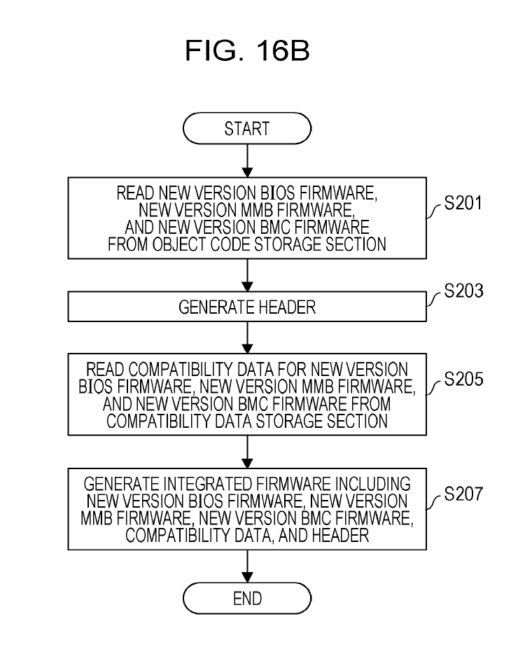

When SC==N does not hold (step S81: No), the third management section 1053 increments the comparison destination counter SC by 1 (step S83). Then, the processing returns to step S77. On the other hand, when SC==N holds (step S81: Yes), the processing is advanced to step S99 of FIG. 16A via a terminal E.

On the other hand, when the ID of the comparison source interface and the ID of the comparison destination interface match each other (step S79: Yes), the third management section 1053 sets the counter c indicating a parameter to c=1 (step S85). The processing is advanced to step S87 of FIG. 16A via a terminal F.

Referring to FIG. 16A, the third management section 1053 determines whether the number of parameters of the comparison source interface and the number of parameters of the comparison destination interface match each other (step S87 of FIG. 16A). Here, the number of parameters is denoted by n.

When the number n of parameters of the comparison source interface and the number n of parameters of the comparison destination interface do not match each other (step S87: No), the processing is advanced to step S93.

On the other hand, when the number n of parameters of the comparison source interface and the number n of parameters of the comparison destination interface match each other (step S87: Yes), the third management section 1053 determines whether the total size of parameters of the comparison source interface and the total size parameters of the comparison destination interface match each other (step S89). Here, the total size of parameters is denoted by s.

When the total size s of parameters of the comparison source interface and the total size s of parameters of the comparison destination interface do not match each other (step S89: No), the processing is advanced to step S93.

On the other hand, when the total size s of parameters of the comparison source interface and the total size s of parameters of the comparison destination interface match each other (step S89: Yes), the third management section 1053 determines whether the size of the parameter indicated by the counter c among the parameters of the comparison source interface and the size of the parameter indicated by the counter c among the parameters of the comparison destination interface match each other (step S91).

When the size of the parameter indicated by the counter c among the parameters of the comparison source interface and the size of the parameter indicated by the counter c among the parameters of the comparison destination interface do not match each other (step S91: No), the third management section 1053 sets the compatibility data stored in the compatibility data storage section 106 and indicating interface compatibility for the pair of the target firmwares to “no” (step S93). Then, the processing is terminated.

On the other hand, when the size of the parameter indicated by the counter c among the parameters of the comparison source interface and the size of the parameter indicated by the counter c among the parameters of the comparison destination interface match each other (step S91: Yes), the third management section 1053 determines whether c==n holds (step S95).

When c==n does not hold (step S95: No), the third management section 1053 increments the counter c by 1 (step S97). Then, the processing returns to step S91.

On the other hand, when c==n holds (step S95: Yes), the third management section 1053 sets the counter SC to SC=1 (that is, initialization) (step S99).

The third management section 1053 determines whether C==N holds (step S101). When C==N does not hold (step S101: No), the third management section 1053 increments the counter C by 1 (step S103). The processing returns to step S75 of FIG. 14 via a terminal G. On the other hand, when C==N holds (step S101: Yes), the processing is terminated.

As above, when there is a possibility that a problem may occur in the communication between firmwares after on-line update, compatibility data indicating interface incompatibility is generated.

Next, processing executed by the integration section 107 is described with reference to FIG. 16B.

First, the integration section 107 reads sets of object code of a new version BIOS firmware, a new version MMB firmware, and a new version BMC firmware from the object code storage section 103 (step S201 of FIG. 16B).

The integration section 107 generates a header including information of a list of firmwares to be integrated (step S203).

The integration section 107 reads the compatibility data (compatibility data generated in the processing by the first management section 1051 and the third management section 1053) for the new version BIOS firmware, new version MMB firmware, and new version BMC firmware from the compatibility data storage section 106 (step S205).

The integration section 107 generates an integrated firmware including the sets of object code read in step S201, the header generated in step S203, and the compatibility data read in step S205 (step S207). Then, the integration section 107 stores the generated integrated firmware into the integrated firmware storage section 108. Then, the processing is terminated.

Execution of the above processing makes it possible to determine whether to preform on-line update based on the generated integrated firmware. In this embodiment, if the compatibility data set to “no” exists, a failure may occur and therefore it is unfavorable to perform on-line update.

In the second embodiment, processing executed by the first management section 1051 is described by using an example of more specific configuration information than the configuration information illustrated in the first embodiment. A basic operation of the first management section 1051 in the second embodiment is the same as in the first embodiment.

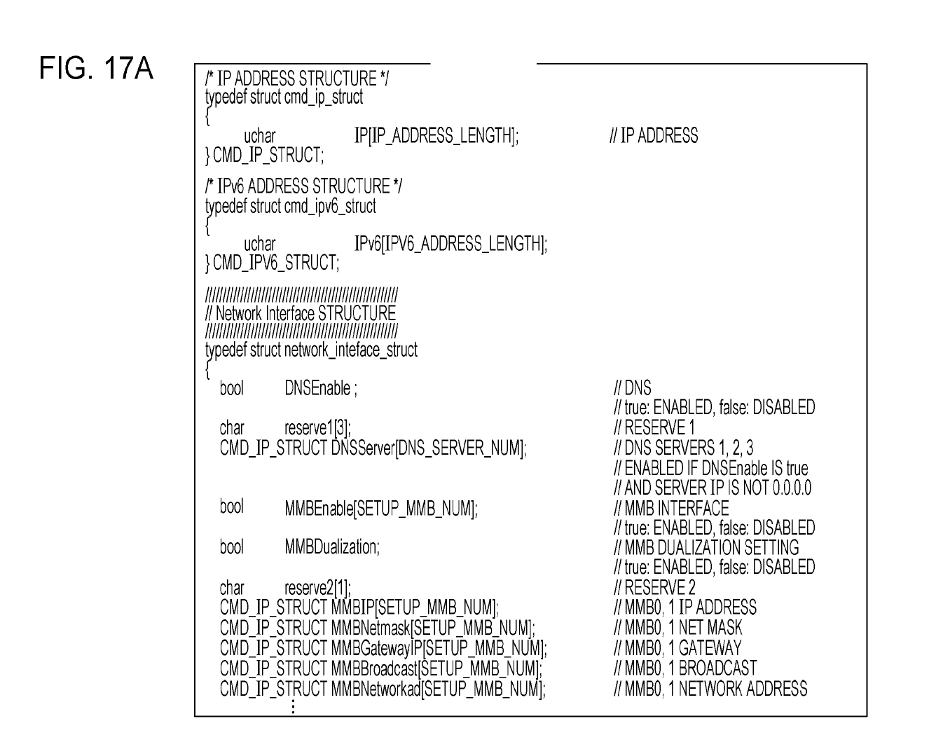

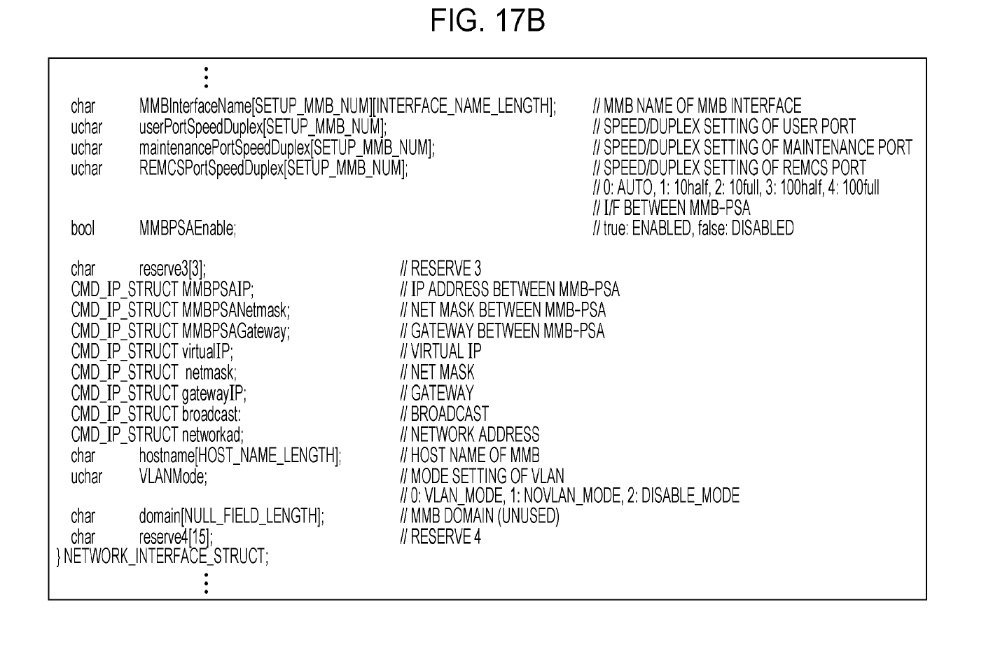

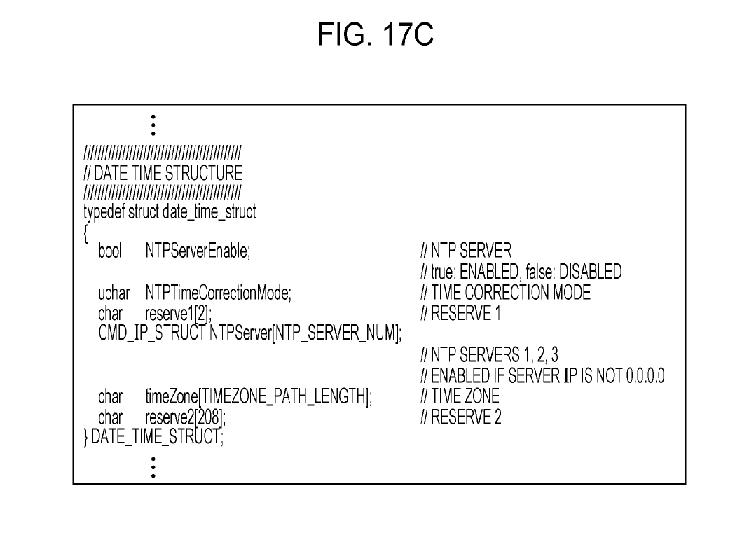

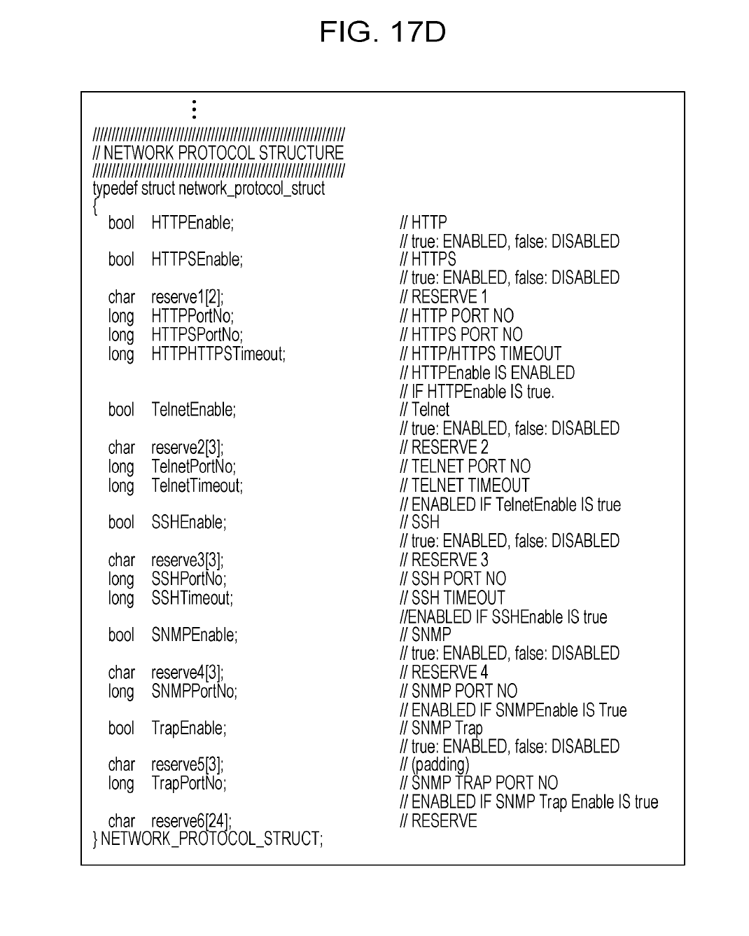

FIGS. 17A to 17D illustrate examples of configuration information of firmwares in the second embodiment.

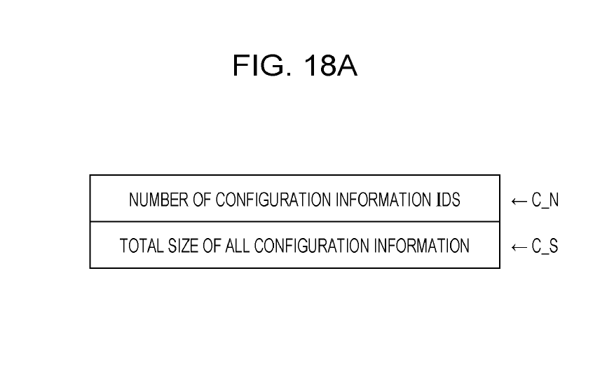

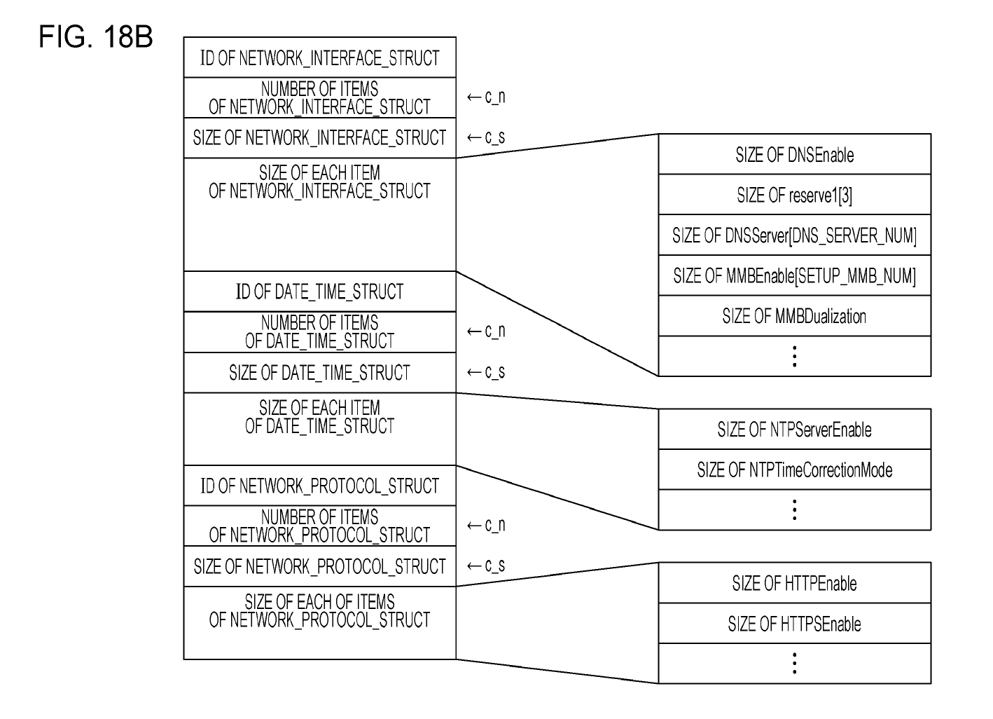

FIGS. 18A and 18B illustrate examples of management data for the configuration information illustrated in FIGS. 17A to 17D. In this embodiment, the number of configuration information IDs is denoted by C_N, and the total size of all configuration information is denoted by C_S, as illustrated in FIG. 18A. Also, the number of items (that is, members) of the configuration information is denoted by c_n, and the size of the configuration information is denoted by c_s, as illustrated in FIG. 18B.

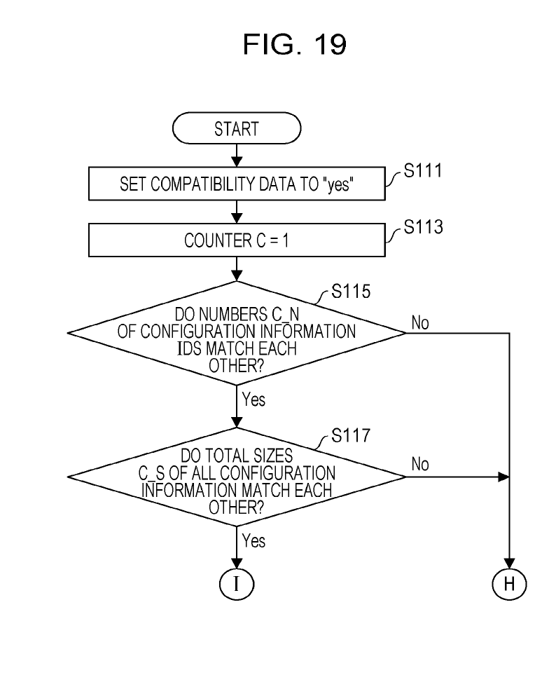

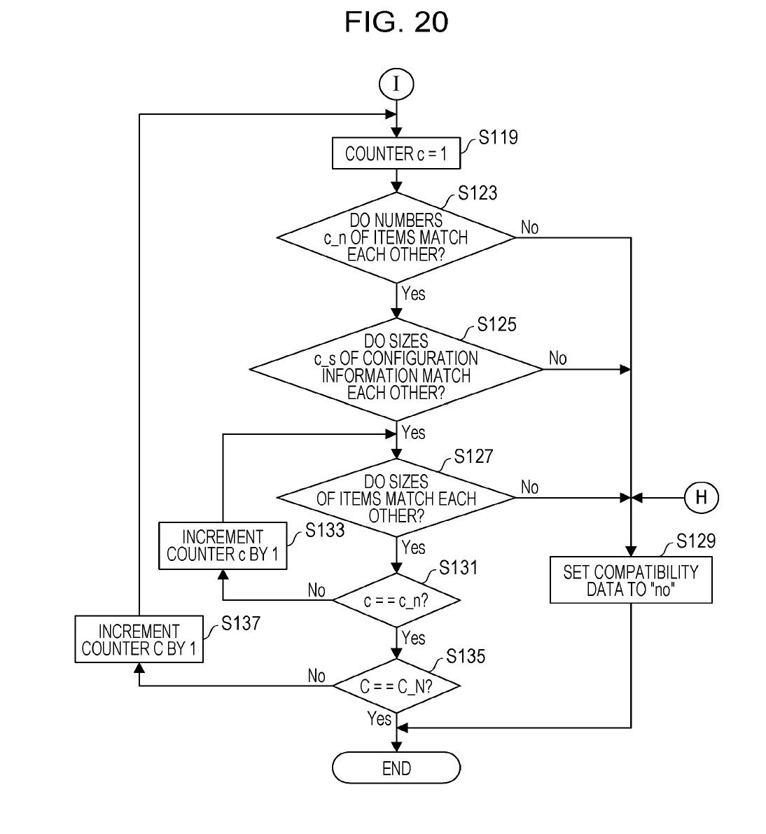

Next, processing executed by the first management section 1051 is described with reference to FIGS. 19 and 20. In the description below, a firmware to be processed is referred to as a target firmware.

The first management section 1051 sets the compatibility data for the configuration of the target firmware stored in the compatibility data storage section 106 to “yes” (step S111 of FIG. 19). The processing of step S111 is equivalent to initialization.

The first management section 1051 sets a counter C indicating a configuration information ID to C=1 (step S113).

For the target firmware, the first management section 1051 reads the management data of the new version firmware and the management data of the old version firmware from the management data storage section 104. Then, the first management section 1051 determines whether the number C_N of configuration information IDs of the new version firmware and the number C_N of configuration information IDs of the old version firmware match each other (step S115).

When the number C_N of configuration information IDs of the new version firmware and the number C_N of configuration information IDs of the old version firmware do not match each other (step S115: No), the new version firmware and the old version firmware are incompatible with each other (in other words, a failure may occur if on-line update from the old version to the new version is performed). Thus, the processing is advanced to step S129 of FIG. 20 via a terminal H.

On the other hand, when the number C_N of configuration information IDs of the new version firmware and the number C_N of configuration information IDs of the old version firmware match each other (step S115: Yes), the first management section 1051 determines whether the total size C_S of all configuration information of the new version firmware and the total size C_S of all configuration information of the old version firmware match each other (step S117).

When the total size C_S of all configuration information of the new version firmware and the total size C_S of all configuration information of the old version firmware do not match each other (step S117: No), the new version firmware and the old version firmware are incompatible with each other (in other words, a failure may occur if on-line update from the old version to the new version is performed). Thus, the processing is advanced to step S129 of FIG. 20 via the terminal H.

On the other hand, when the total size C_S of all configuration information of the new version firmware and the total size C_S of all configuration information of the old version firmware match each other (step S117: Yes), the processing is advanced to step S119 of FIG. 20 via a terminal I.

Referring to FIG. 20, the first management section 1051 sets a counter c indicating an item to c=1 (step S119 of FIG. 20).

The first management section 1051 determines whether the number c_n of new version items and the number c_n of old version items match each other for the configuration information indicated by the counter C (for example, NETWORK_INTERFACE_STRUCT 1 when the value of the counter C is 1) (step S123).

When the number c_n of new version items and the number c_n of old version items do not match each other (step S123: No), the new version firmware and the old version firmware are incompatible with each other (in other words, a failure may occur if on-line update from the old version to the new version is performed). Thus, the processing is advanced to step S129.

On the other hand, when the number c_n of new version items and the number c_n of old version items match each other (step S123: Yes), the first management section 1051 determines whether the size c_s of new version configuration information and the size c_s of old version configuration information match each other for the configuration information indicated by the counter C (step S125). Here, the size of configuration information is denoted by c_s.

When the size c_s of the new version configuration information and the size c_s of old version configuration information do not match each other (step S125: No), the new version firmware and the old version firmware are incompatible with each other (in other words, a failure may occur if on-line update from the old version to the new version is performed). Thus, the processing is advanced to step S129.

When the size c_s of the new version configuration information and the size c_s of the old version configuration information match each other (step S125: Yes), the first management section 1051 determines whether the size of the new version item indicated by the counter c and the size of the old version item indicated by the counter c match each other for the configuration information indicated by the counter C (step S127).

When the size of the new version item indicated by the counter c and the size of the old version item indicated by the counter c do not match each other for the configuration information indicated by the counter C (step S127: No), the first management section 1051 sets the compatibility data for the configuration of the target firmware stored in the compatibility data storage section 106 to “no” (step S129). Then, the processing is terminated.

On the other hand, when the size of the new version item indicated by the counter c and the size of the old version item indicated by the counter c match each other for the configuration information indicated by the counter C (step S127: Yes), the first management section 1051 determines whether c==c_n holds (that is, c is equal to c_n) (step S131).

When c==c_n does not hold (step S131: No), the first management section 1051 increments the value of the counter c by 1 (step S133). Then, the processing returns to step S127.

On the other hand, when c==c_n holds (step S131: Yes), the first management section 1051 determines whether C==C_N holds (that is, C is equal to C_N) (step S135).

When C==C_N does not hold (step S135: No), the first management section 1051 increments the counter C by 1 (step S137). Then, the processing returns to step S119. On the other hand, when C==C_N holds (step S135: Yes), the processing is terminated.

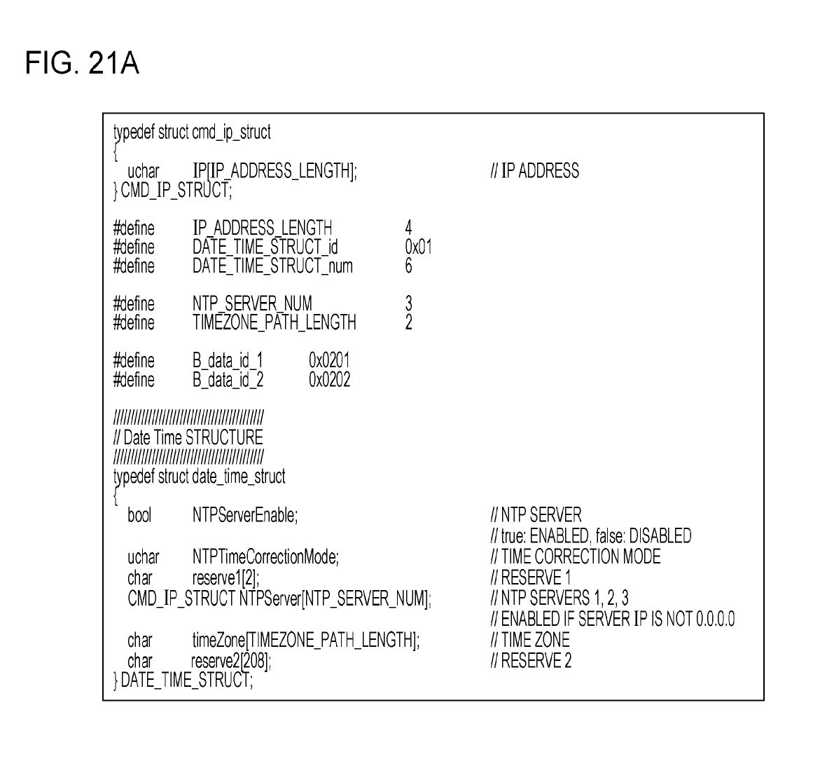

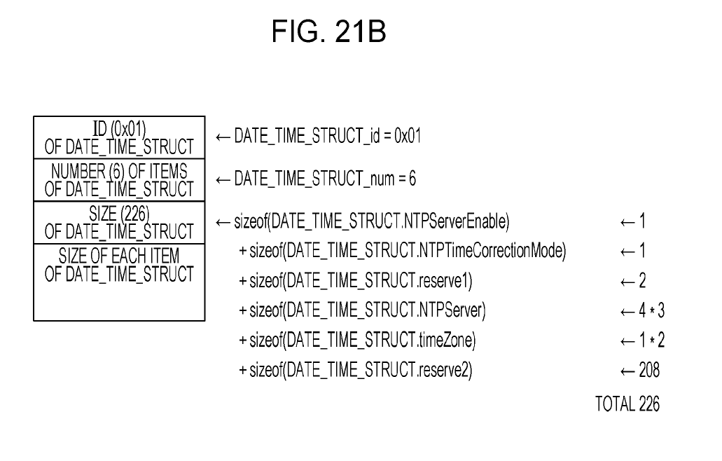

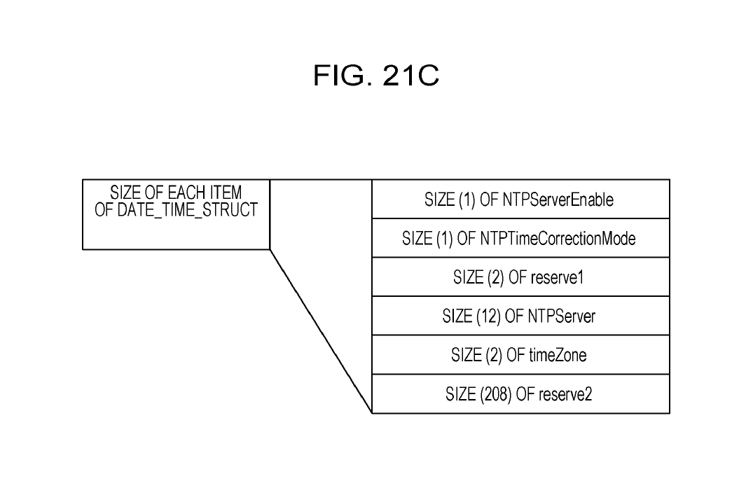

FIGS. 21A to 24C illustrate specific examples of detection of a difference in the configuration information.

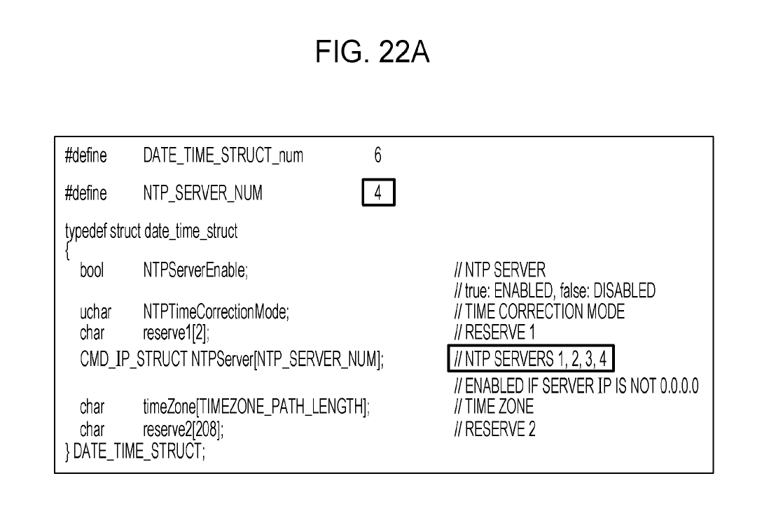

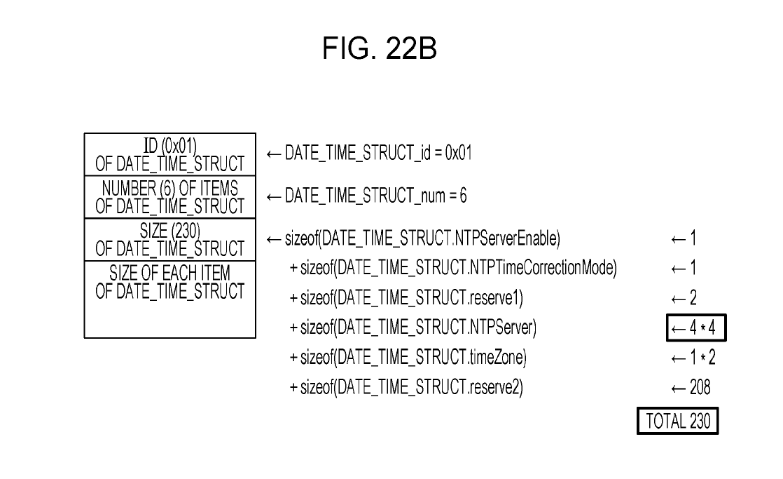

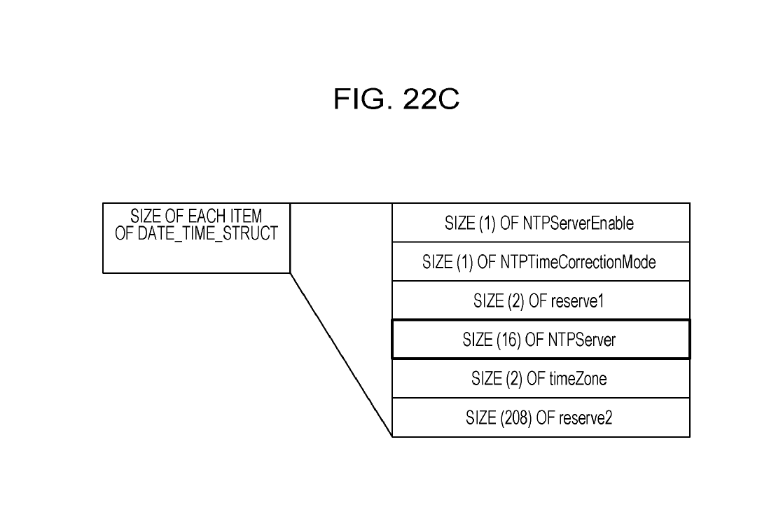

FIG. 21A illustrates configuration information of a comparison target. FIG. 21B illustrates the management data for the configuration information illustrated in FIG. 21A. Further, FIG. 21C illustrates the detail of the size of each item illustrated in FIG. 21B. In FIGS. 22A to 24C, revised portions of the configuration information are indicated in thick frames.

Assume that NTP_SERVER_NUM is revised from 3 to 4 as illustrated in FIG. 22A. In this case, the management data is revised as illustrated in FIGS. 22B and 22C. Specifically, as the size of DATE_TIME_STRUCT. NTPServer is revised from 12 (=4*3) to 16 (=4*4), the size of DATE_TIME_STRUCT is revised from 226 to 230. In this case, it is determined that there is a difference in the configuration information.

Thus, according to this embodiment, when the total size of all configuration information is revised, the revision thereof is detected.

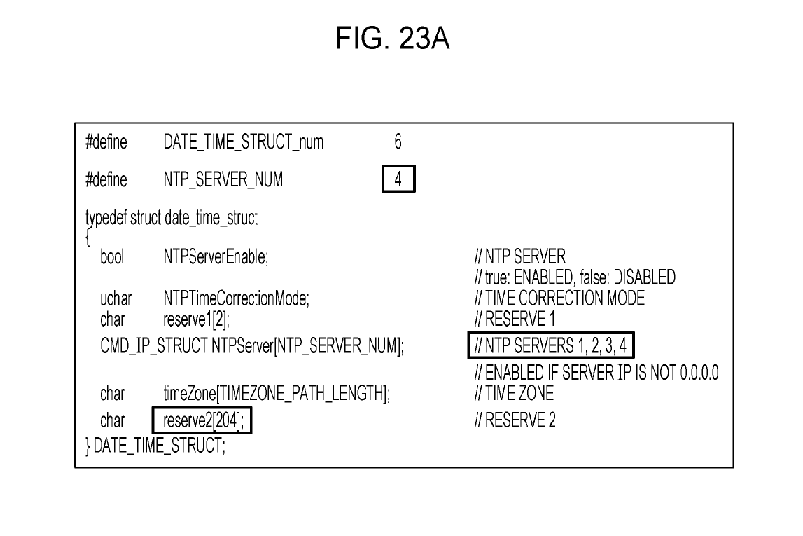

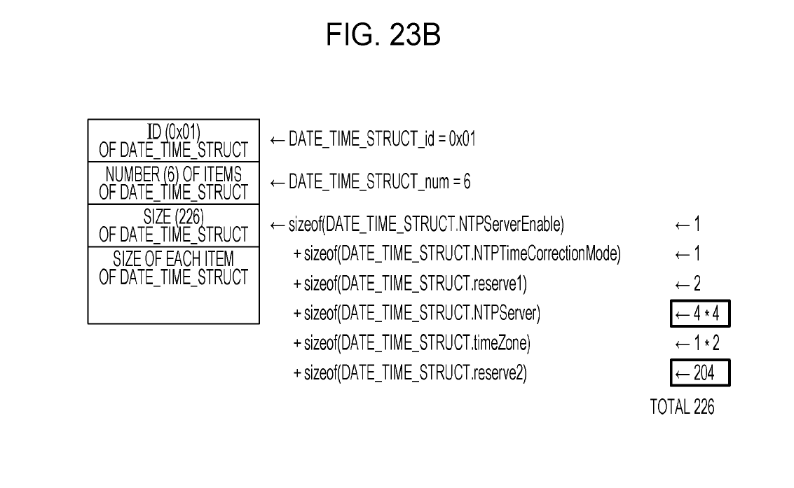

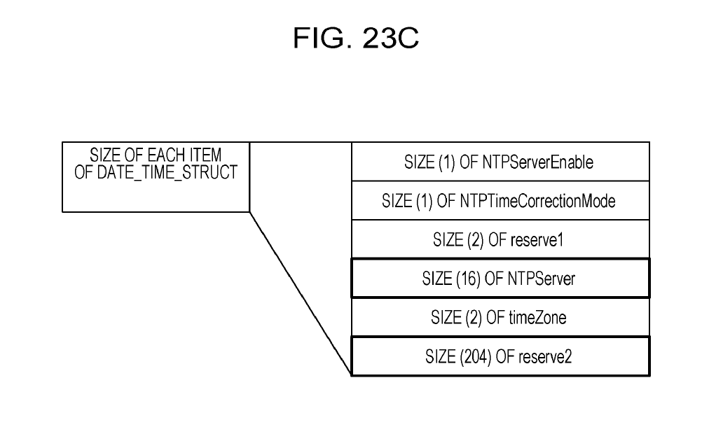

Assume that NTP_SERVER_NUM is revised from 3 to 4, and reserve2 [208] is revised to reserve2 [204], as illustrated in FIG. 23A. In this case, the management data is revised as illustrated in FIGS. 23B and 23C. Specifically, the size of DATE_TIME_STRUCT. NTPServer is revised from 12 (4*3) to 16 (=4*4), and the size of DATE_TIME_STRUCT. Reserve2 is revised from 208 to 204. However, the total size of all configuration information is not revised. Even in this case, it is determined that there is a difference in the configuration information.

Thus, according to this embodiment, even if the total size of all configuration information is not revised, but if the size of any item (or member) is revised, the revision thereof is detected.

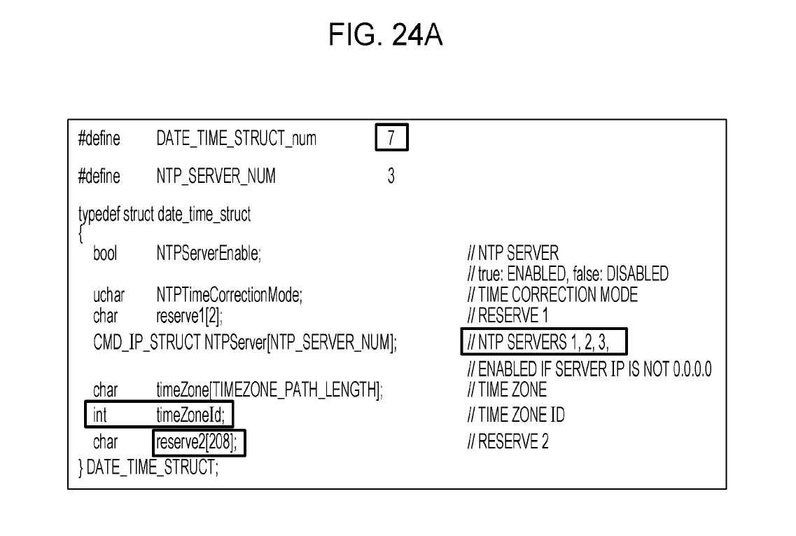

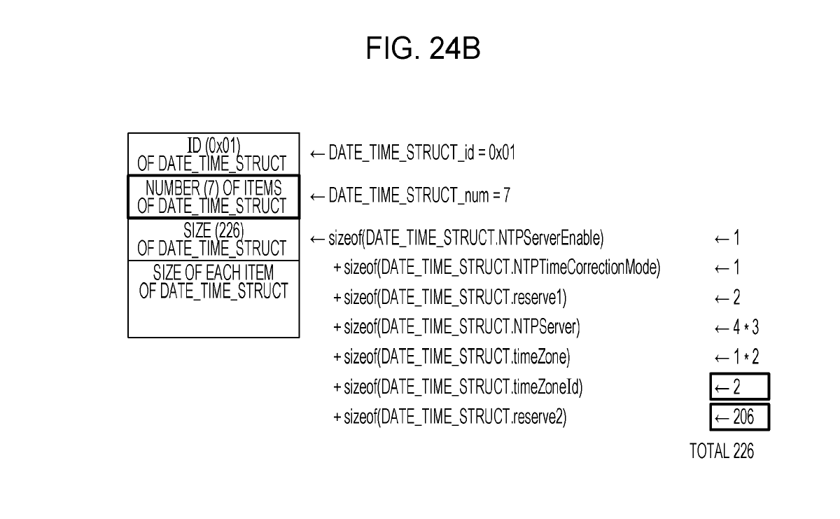

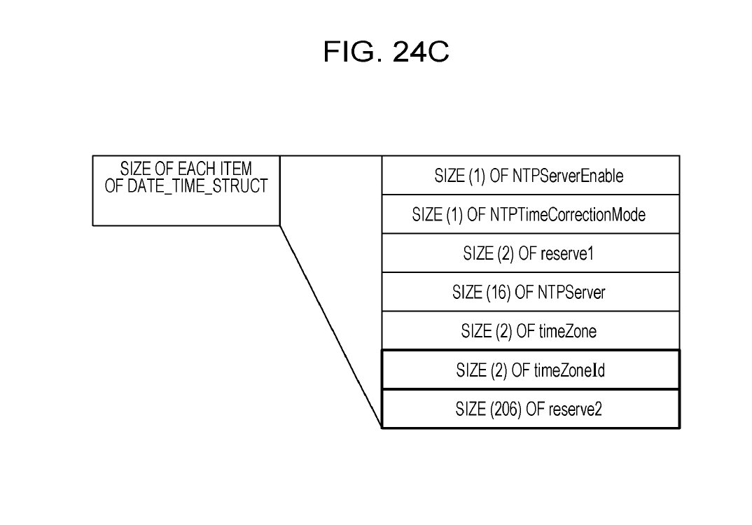

Assume that DATE_TIME_STRUCT_num is revised from 6 to 7, the item “timeZoneId” is added, and reserve2 [208] is revised to reserve2 [206], as illustrated in FIG. 24A. In this case, the management data is revised as illustrated in FIGS. 24B and 24C. Specifically, DATE_TIME_STRUCT.timeZoneId of the size “2” is added, and the size of DATE_TIME_STRUCT. Reserve2 is revised from 208 to 206. However, the total size of all configuration information is not revised. Even in this case, it is determined that there is a difference in the configuration information.

Thus, according to this embodiment, even if the total size of all configuration information is not revised, but if the number of items is revised, it is determined that there is a difference in the configuration information.

In the third embodiment, processing executed by the second management section 1052 is described by using an example of more specific interface than the interface illustrated in the first embodiment. A basic operation of the second management section 1052 in the third embodiment is the same as in the first embodiment.

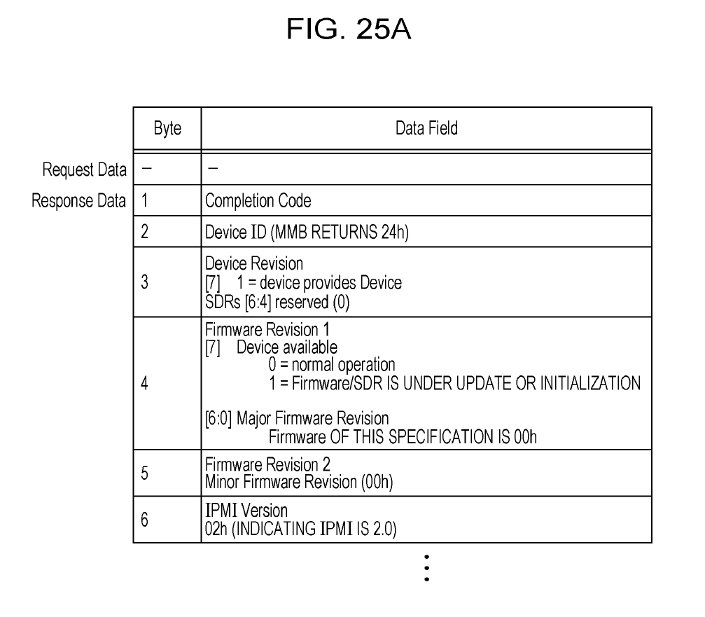

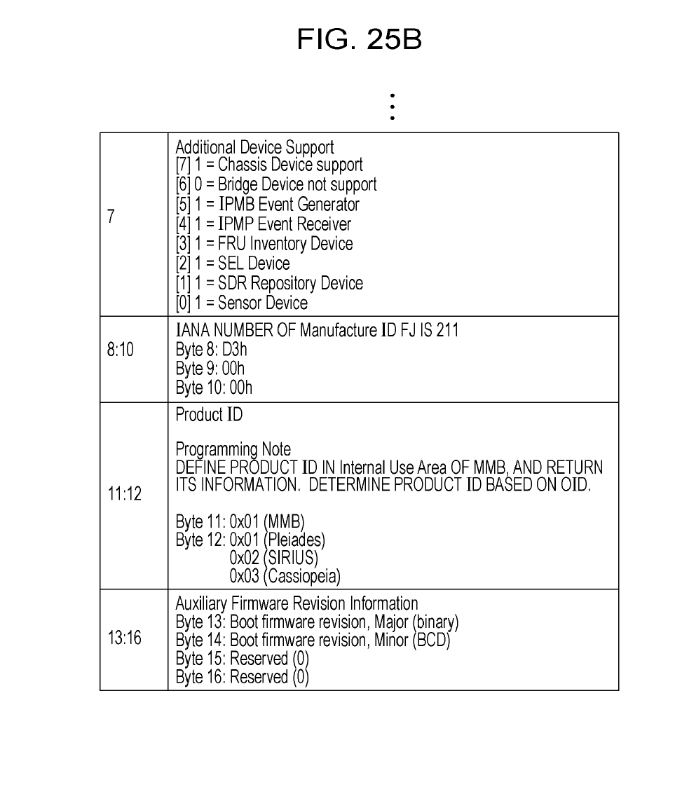

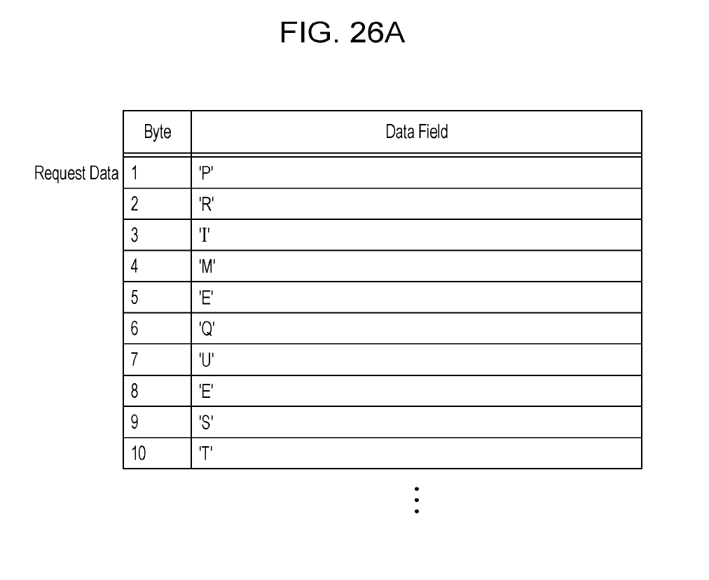

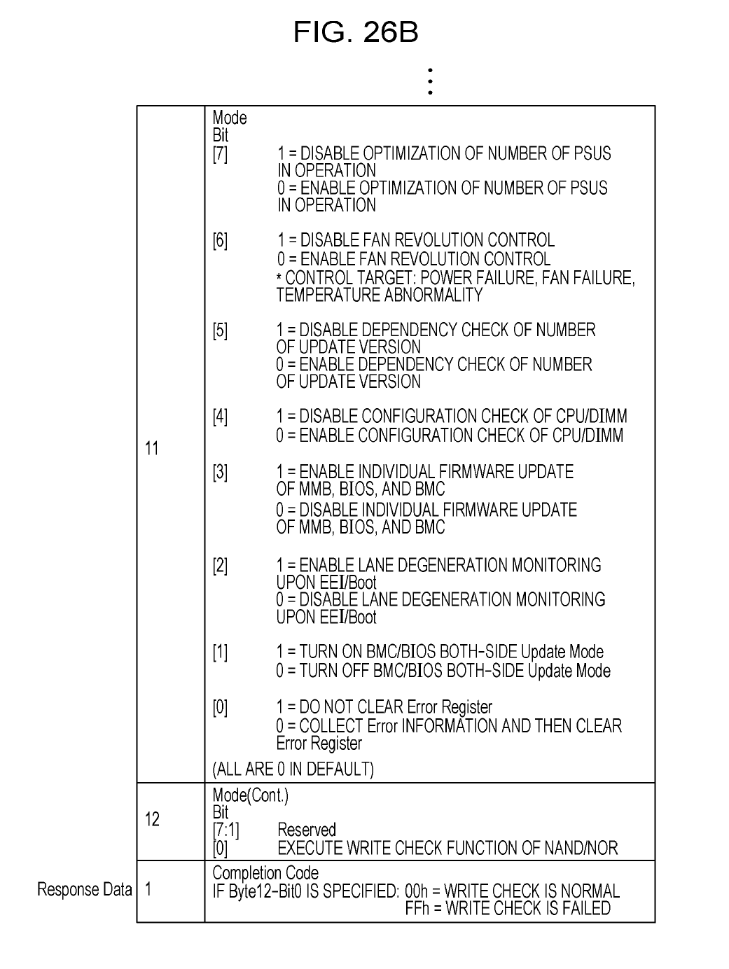

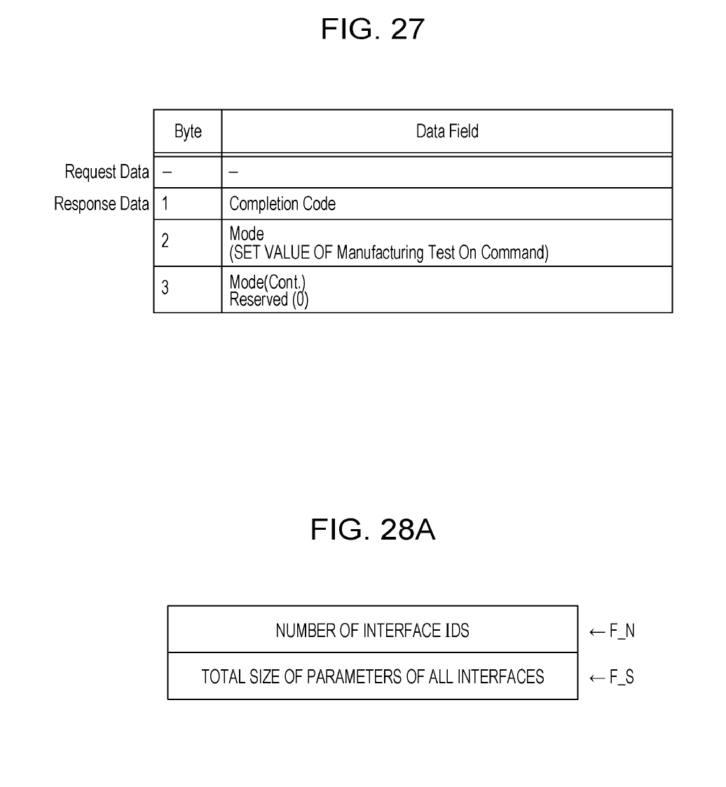

FIGS. 25A to 27 illustrate examples of interfaces of a firmware in the third embodiment. FIGS. 25A and 25B are diagrams illustrating fields of a command named Get Device ID. FIGS. 26A and 26B are diagrams illustrating fields of a command named Manufacturing Test On Command. FIG. 27 is a diagram illustrating fields of a command named GetManufacturing Test On Command.

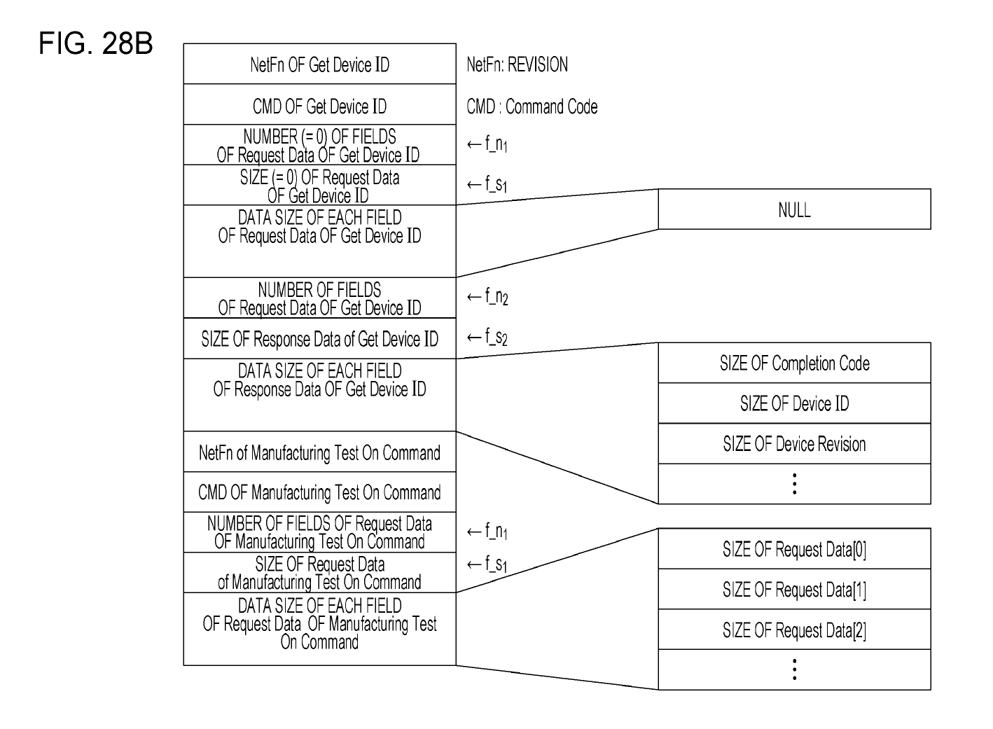

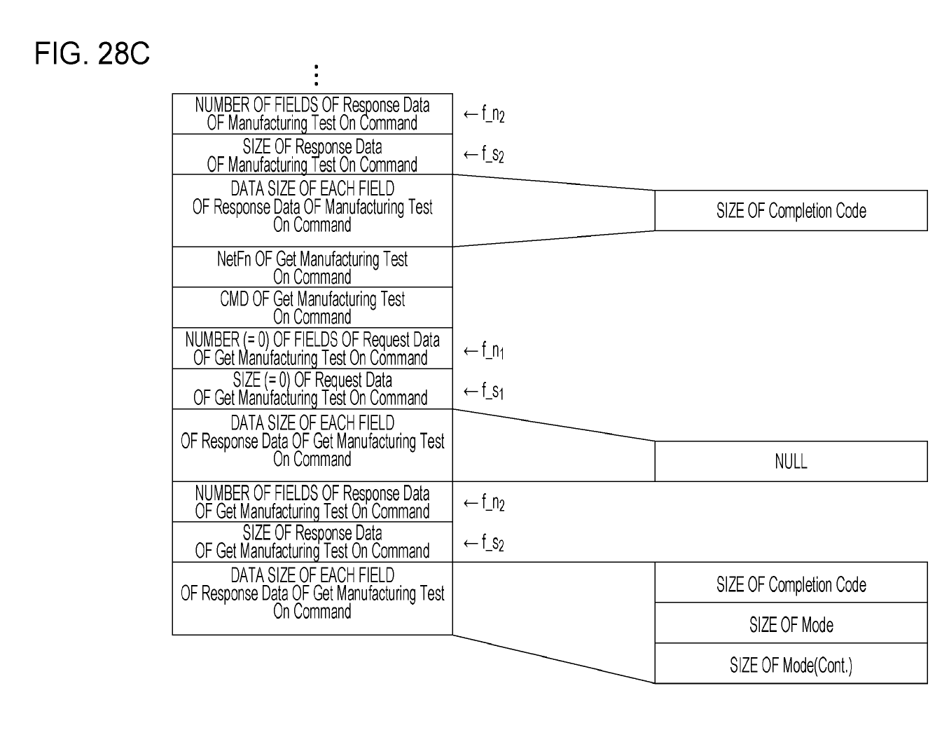

FIGS. 28A to 28C illustrate examples of management data for the interfaces illustrated in FIGS. 25A to 27. Assume that in this embodiment, the number of all interfaces is denoted by F_N, and the total size of parameters of all interfaces is denoted by F_S, as illustrated in FIG. 28A. Assume that the number of fields of request data is denoted by f_n₁; the size of request data is denoted by f_s₁; the number of fields of response data is denoted by f_n₂, and the size of response data is denoted by f_s2, as illustrated in FIGS. 28B and 28C.

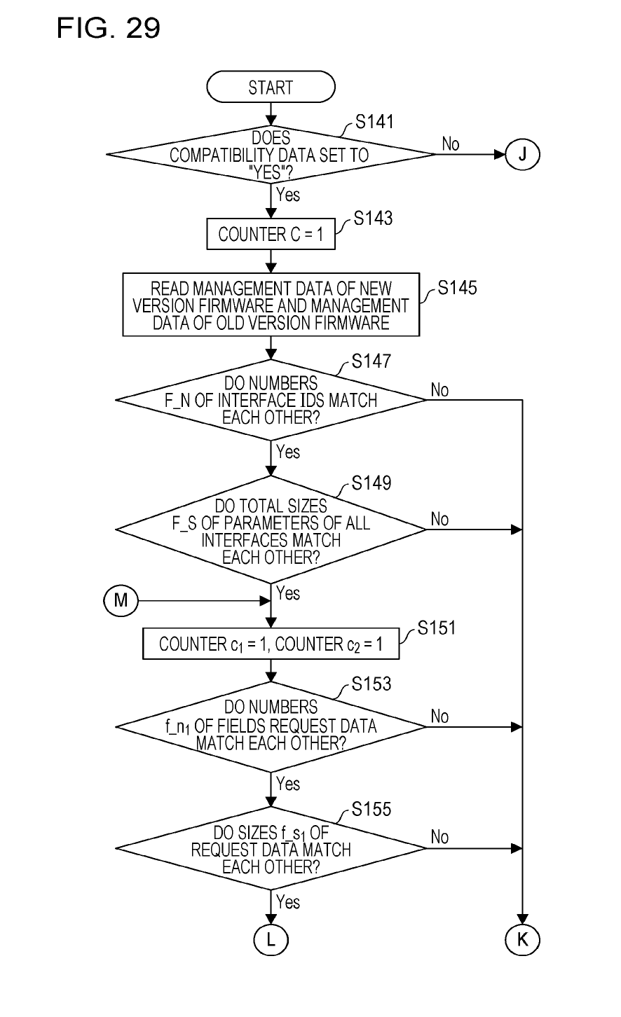

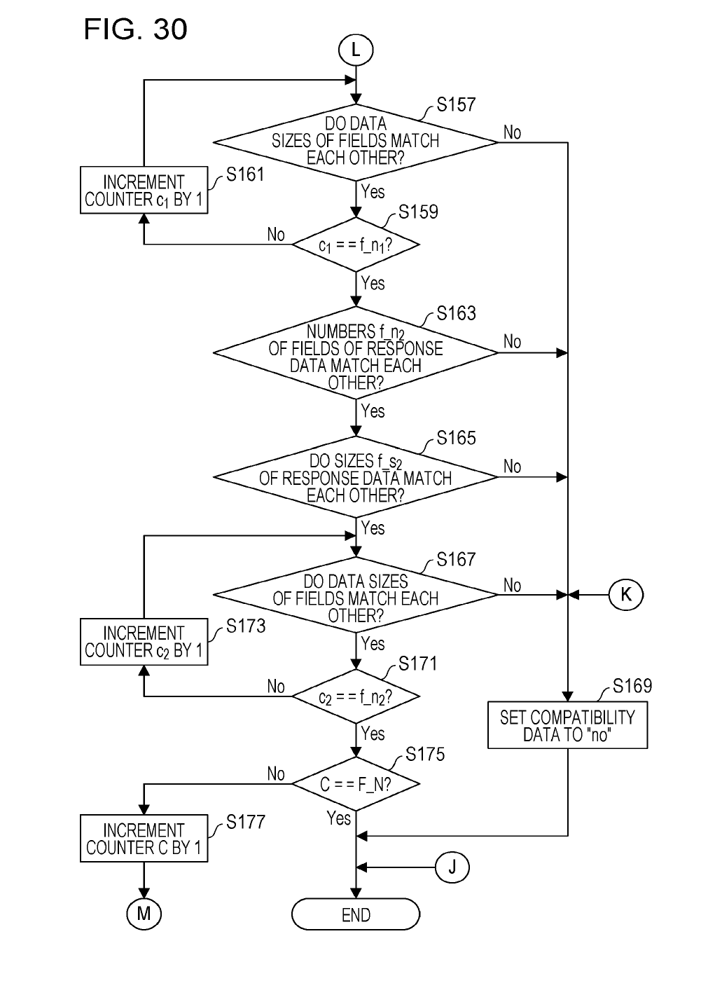

Next, processing executed by the second management section 1052 is described with reference to FIGS. 29 and 30. In the description below, a firmware to be processed is referred to as a target firmware.

The second management section 1052 determines whether the compatibility data for the interface of the target firmware stored in the compatibility data storage section 106 is set to “yes” (step S141 of FIG. 29).

When compatibility data for the interface of the target firmware stored in the compatibility data storage section 106 is not set to “yes” (step S141: No), the new version firmware and the old version firmware are incompatible with each other (in other words, a failure may occur if on-line update from the old version to the new version is performed). Thus, the processing is advanced to FIG. 30 via a terminal J and ends.

When compatibility data for the interface of the target firmware stored in the compatibility data storage section 106 is set to “yes” (step S141: Yes), the second management section 1052 sets a counter C indicating the interface ID to C=1 (step S143).

The second management section 1052 reads the management data of the new version firmware and the management data of the old version firmware from the management data storage section 104 for the target firmware (step S145).

The second management section 1052 determines whether the number F_N of interfaces IDs of the new version firmware and the number F_N of interface IDs of the old version firmware match each other (step S147).

When the number F_N of interface IDs of the new version firmware and the number F_N of interface IDs of the old version firmware do not match each other (step S147: No), the new version firmware and the old version firmware are incompatible with each other (in other words, a failure may occur if on-line update from the old version to the new version is performed). Thus, the processing is advanced to step S169 of FIG. 30 via a terminal K.

On the other hand, when the number F_N of interface IDs of the new version firmware and the number F_N of interface IDs of the old version firmware match each other (step S147: Yes), the second management section 1052 determines whether the total size F_S of parameters of all interfaces of the new version firmware and the total size F_S of parameters of all interfaces of the old version firmware match each other (step S149).

When the total size F_S of parameters of all interfaces of the new version firmware and the total size F_S of parameters of all interfaces of the old version firmware do not match each other (step S149: No), the new version firmware and the old version firmware are incompatible with each other (in other words, a failure may occur if on-line update from the old version to the new version is performed). Thus, the processing is advanced to step S169 of FIG. 30 via the terminal K.

On the other hand, when the total size F_S of parameters of all interfaces of the new version firmware and the total size F_S of parameters of all interfaces of the old version firmware match each other (step S149: Yes), the second management section 1052 set a counter c₁ indicating request data to c₁=1, and sets a counter c₂ indicating response data to c₂=1 (step S151).

The second management section 1052 determines whether the number f_n₁ of fields of the new version request data and the number f_n₁ of fields of the old version request data match each other for the interface indicated by the counter C (for example, Get Device ID when the value of the counter C is 1) (step S153).

When the number f_n₁ of fields of the new version request data and the number f_n₁ of fields of the old version request data do not match each other for the interface indicated by the counter C (step S153: No), the processing is advanced to step S169 of FIG. 30 via the terminal K.

On the other hand, when the number f_n₁ of fields of the new version request data and the number f_n₁ of fields of the old version request data match each other for the interface indicated by the counter C (step S153: Yes), the second management section 1052 determines whether the size f_s₁ of the new version request data and the size f_s₁ of the old version request data match each other for the interface indicated by the counter C (step S155).

When the size f_s₁ of the new version request data and the size f_s₁ of the old version request data do not match each other for the interface indicated by the counter C (step S155: No), the processing is advanced to step S169 of FIG. 30 via the terminal K.

On the other hand, when the size f_s₁ of the new version request data and the size f_s₁ of the old version request data match each other for the interface indicated by the counter C (step S155: Yes), the processing is advanced to step S157 of FIG. 30 via a terminal L.

Referring to FIG. 30, the second management section 1052 determines whether the data size of the old version field indicated by the counter c₁ and the data size of the new version field indicated by the counter c₁ match each other for the interface indicated by the counter C (step S157 of FIG. 30).

When the data size of the old version field indicated by the counter c₁ and the data size of the new version field indicated by the counter c₁ do not match each other for the interface indicated by the counter C (step S157: No), the processing is advanced to step S169.

On the other hand, when the data size of the old version field indicated by the counter c₁ and the data size of the new version field indicated by the counter c₁ match each other for the interface indicated by the counter C (step S157: Yes), the second management section 1052 determines whether c₁=f_n₁ holds (that is, c₁ is equal to f_n₁) (step S159).

When c₁==f_n₁ does not hold (step S159: No), the second management section 1052 increments the counter c₁ by 1 (step S161). Then, the processing returns to step S157.

On the other hand, when c₁==f_n₁ holds (step S159: Yes), the second management section 1052 determines whether the number f_n₂ of fields of the new version response data and the number f_n₂ of fields of the old version response data match each other for the interface indicated by the counter C (step S163).

When the number f_n₂ of fields of the new version response data and the number f_n₂ of fields of the old version response data do not match each other for the interface indicated by the counter C (step S163: No), the processing is advanced to step S169.

On the other hand, when the number f_n₂ of fields of the new version response data and the number f_n₂ of fields of the old version response data match each other for the interface indicated by the counter C (step S163: Yes), the second management section 1052 determines whether the size f_s₂ of the new version response data and the size f_s₂ of the old version response data match each other for the interface indicated by the counter C (step S165).

When the size f_s₂ of the new version response data and the size f_s₂ of the old version response data do not match each other for the interface indicated by the counter C (step S165: No), the processing is advanced to step S169.

On the other hand, when the size f_s₂ of the new version response data and the size f_s₂ of the old version response data match each other for the interface indicated by the counter C (step S165: Yes), the second management section 1052 determines whether the data size of the old version field indicated by the counter c₂ and the data size of the new version field indicated by the counter c₂ match each other for the interface indicated by the counter C (step S167).

When the data size of the old version field indicated by the counter c₂ and the data size of the new version field indicated by the counter c₂ do not match each other for the interface indicated by the counter C (step S167: No), the second management section 1052 sets the compatibility data for the interface of the target firmware stored in the compatibility data storage section 106 to “no” (step S169). Then, the processing is terminated.

On the other hand, when the data size of the old version field indicated by the counter c₂ and the data size of the new version field indicated by the counter c₂ match each other for the interface indicated by the counter C (step S167: Yes), the second management section 1052 determines whether c₂==f_n₂ holds (that is, c₂ is equal to f_n₂) (step S171).

When c₂==f_n₂ does not hold (step S171: No), the second management section 1052 increments the counter c₂ by 1 (step S173). Then, the processing returns to step S167.

On the other hand, when c₂==f_n₂ holds (step S171: Yes), the second management section 1052 determines whether C==F_N holds (that is, C is equal to F_N) (step S175).

When C==F_N does not hold (step S175: No), the second management section 1052 increments the counter C by 1 (step S177). Then, the processing returns to step S151 of FIG. 29 via a terminal M. On the other hand, when C==F_N holds (step S175: Yes), the processing is terminated.

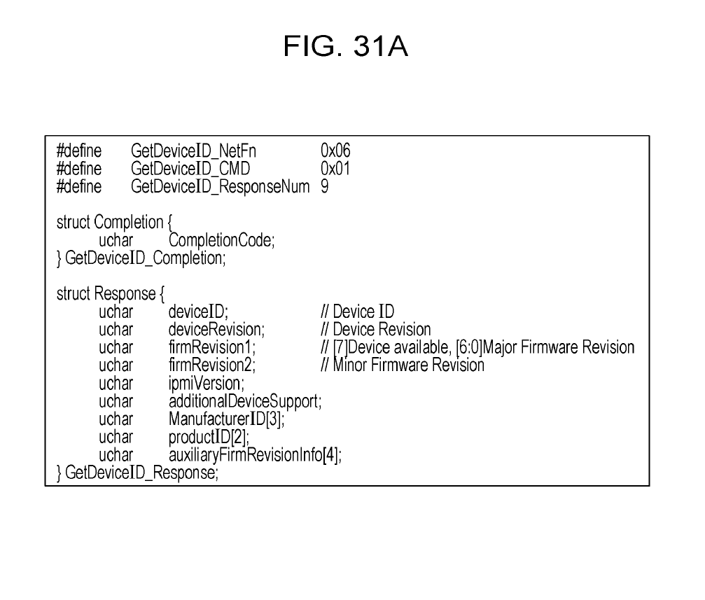

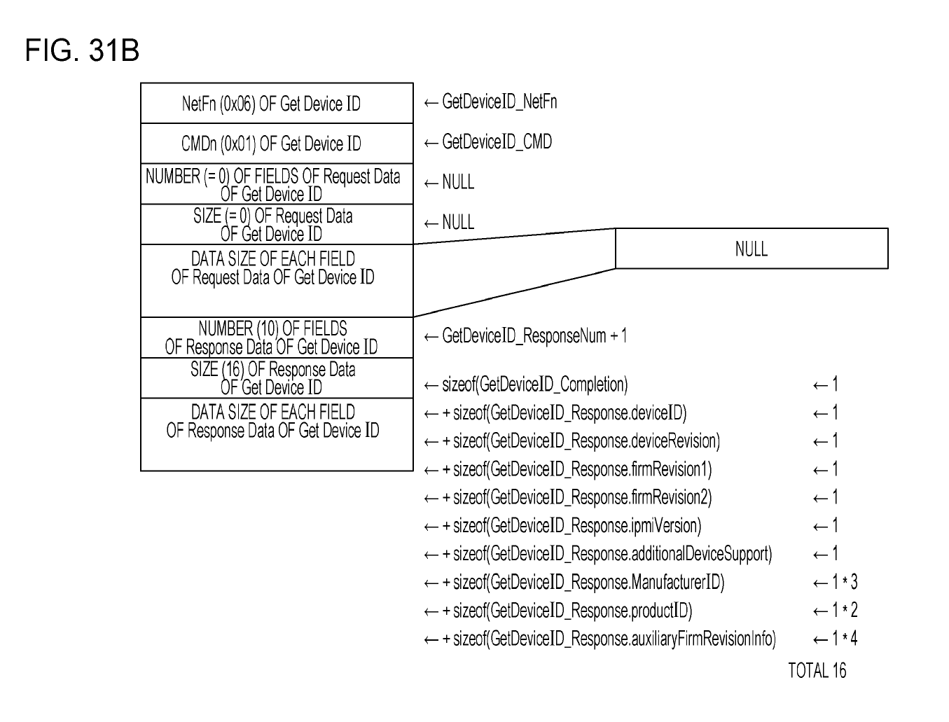

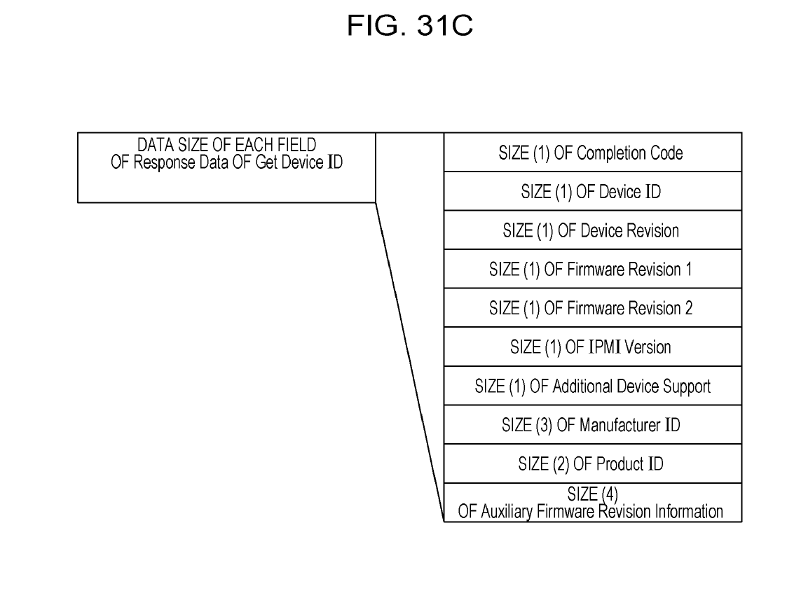

FIGS. 31A to 34C illustrate specific examples of detection of a difference in the interface.

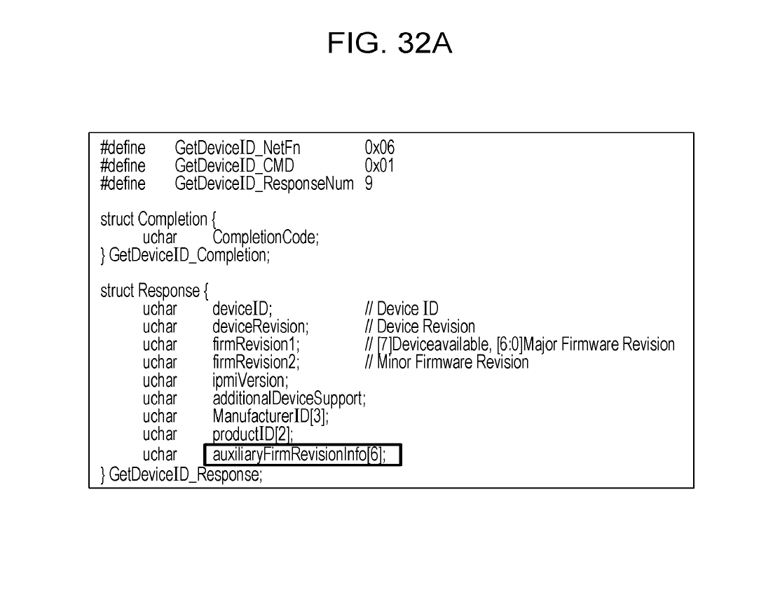

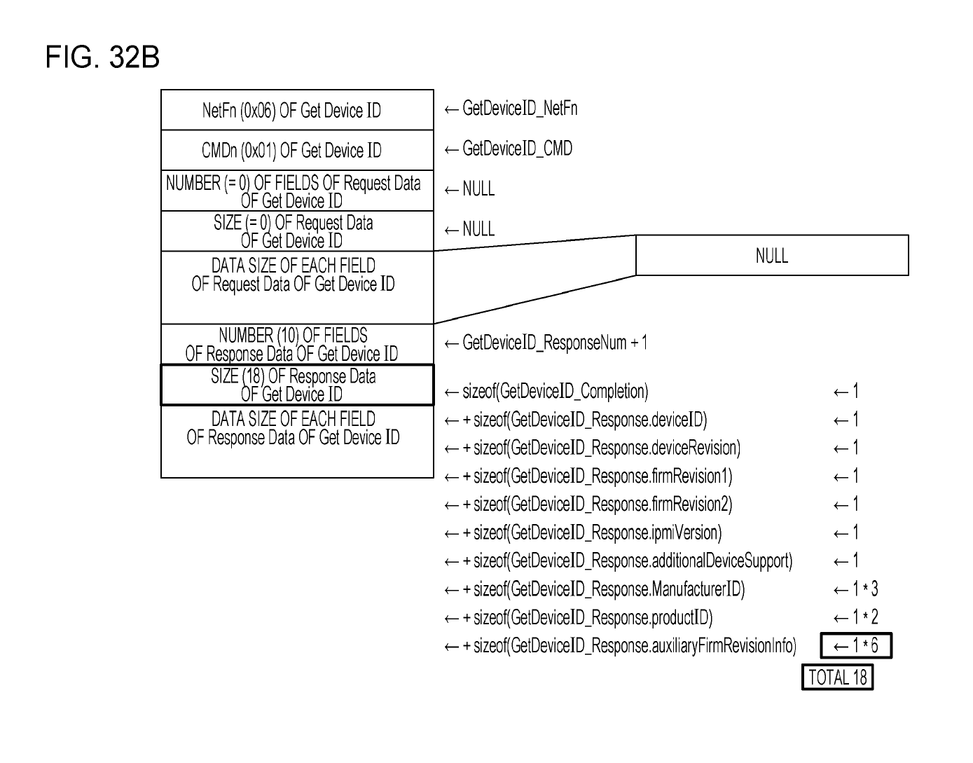

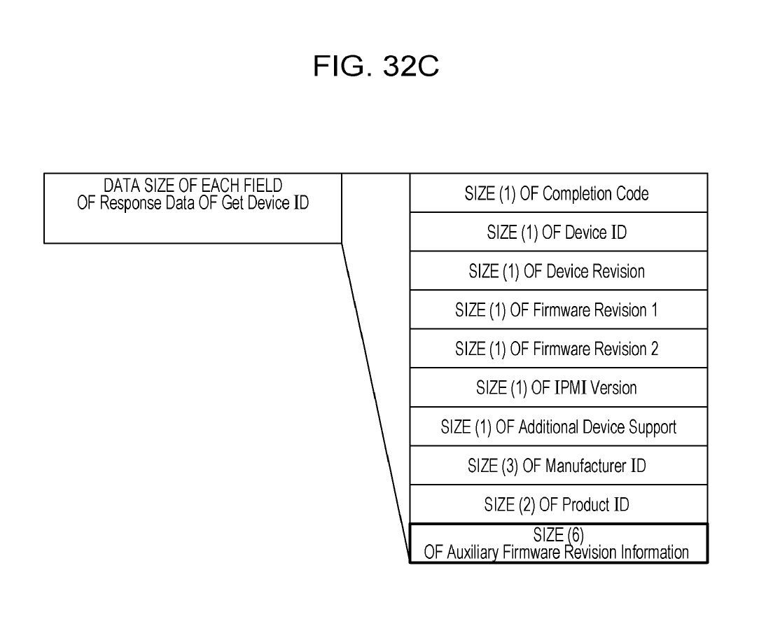

FIG. 31A illustrates the interface of a comparison target. FIG. 31B illustrates the management data for the interface illustrated in FIG. 31A. Further, FIG. 31C illustrates the detail of the data size of each field illustrated in FIG. 31B. In FIGS. 32A to 34C, revised portions of the interface are indicated in thick frames.

Assume that auxiliaryFirmRevisionInfo [4] is revised to auxiliaryFirmRevisionInfo [6], as illustrated in FIG. 32A. In this case, the management data is revised as illustrated in FIGS. 32B and 32C. Specifically, the size of GetDeviceID_Response.auxiliaryFirmRevisionInfo is revised from 4 (=1*4) to 6 (=1*6), and thereby the total size is revised from 16 to 18. In this case, it is determined that there is a difference in the interface.

Thus, according to this embodiment, when the total data size of parameters is revised, the revision thereof is detected.

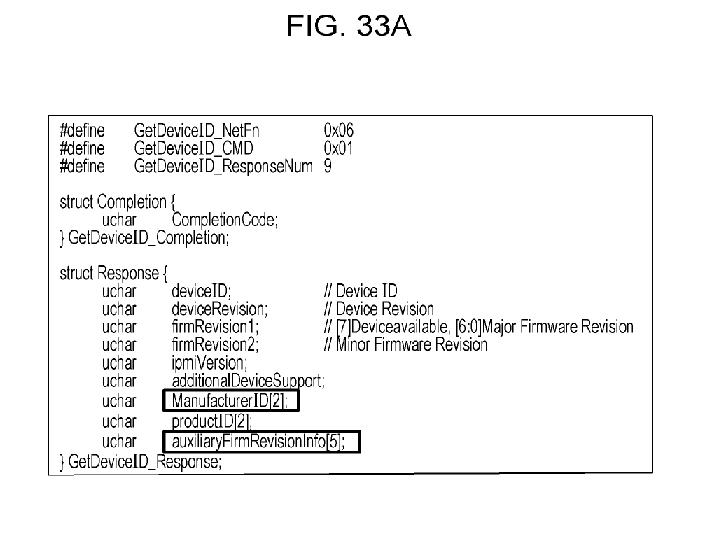

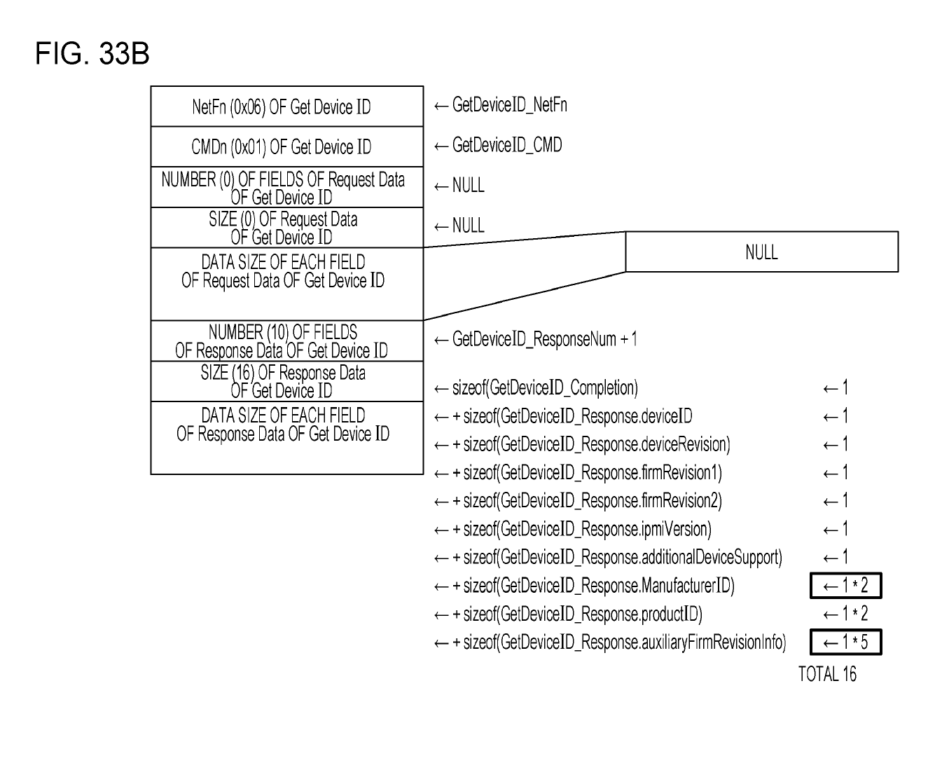

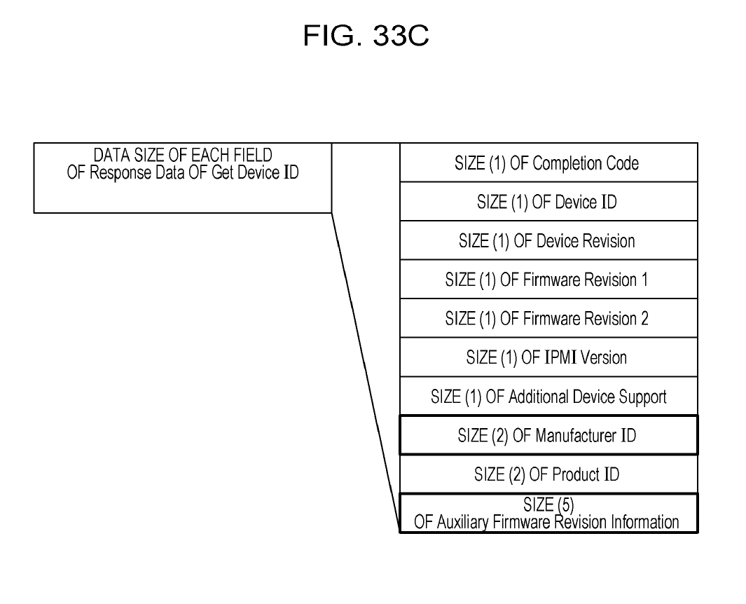

Also, assume that ManufacturerID [3] is revised to ManufacturerID [2], and auxiliaryFirmRevisionInfo [4] is revised to auxiliaryFirmRevisionInfo [5], as illustrated in FIG. 33A. In this case, the management data is revised as illustrated in FIGS. 33B and 33C. Specifically, the size of GetDeviceID_Response.ManufacturerID is revised from 3 (=1*3) to 2 (=1*2), and the size of GetDeviceID_Response.auxiliaryFirmRevisionInfo is revised from 4 (=1*4) to 5 (=1*5). However, the total data size of parameters is not revised. In this case, it is determined that there is a difference in the configuration information.

Thus, according to this embodiment, even if the total data size of parameters is not revised, but if the data size of any parameter is revised, the revision thereof is detected.

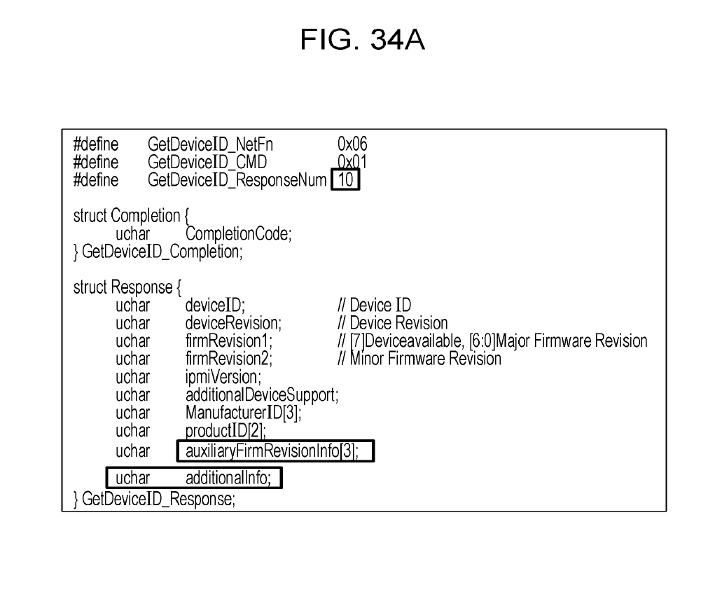

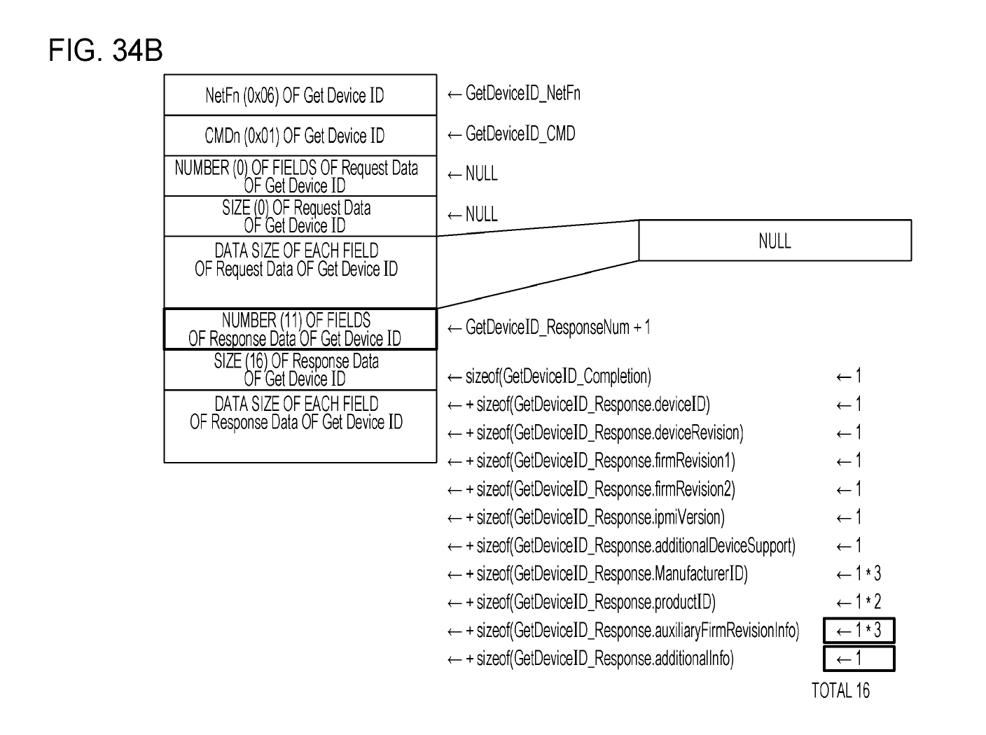

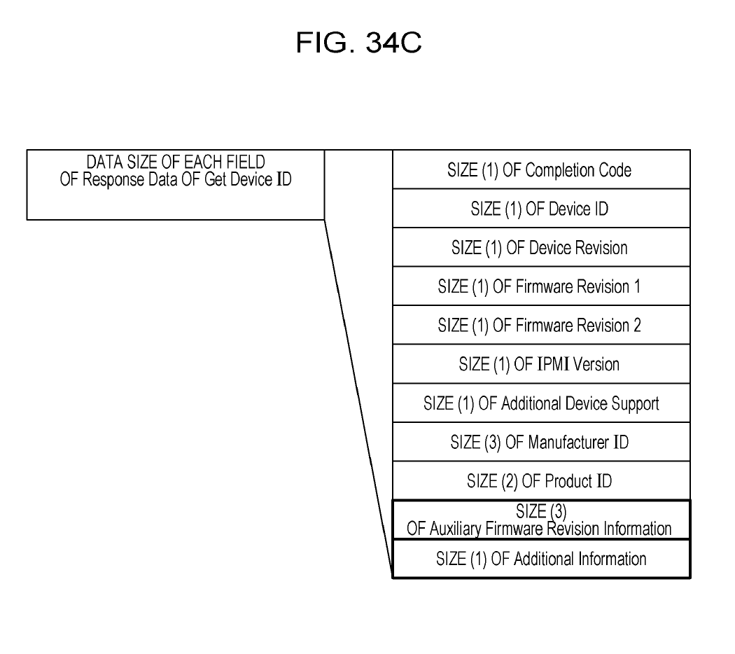

Also, assume that the size of GetDeviceID_ResponseNum is revised from 9 to 10, auxiliaryFirmRevisionInfo [4] is revised to auxiliaryFirmRevisionInfo [3], and a field “additionalInfo” is added, as illustrated in FIG. 34A. In this case, the management data is revised as illustrated in FIGS. 34B and 34C. Specifically, as a field having the size of 1 is added, the number of fields of response data is revised from 10 to 11, the size of GetDeviceID_Response.auxiliaryFirmRevisionInfo is revised from 4 (=1*4) to 3 (=1*3), and GetDeviceID_Response.additionalInfo having the size of 1 is added. However, the total data size of parameters is not revised. In this case, it is determined that there is a difference in the configuration information.

Thus, according to this embodiment, even if the total data size of parameters is not revised, but if the number of parameters is revised, it is determined that there is a difference in the configuration information.

Although the embodiments of the present disclosure are described above, the present disclosure is not limited thereto. For example, the functional block configuration of the information processing apparatus 1 described above may be different from an actual program modular configuration.

Also, the data configuration described above is just an example, and is not limited thereto. Further, even in the process flow, the order of steps in processing may be changed as far as the change does not cause a change of the processing result. Further, processing may be executed in parallel.

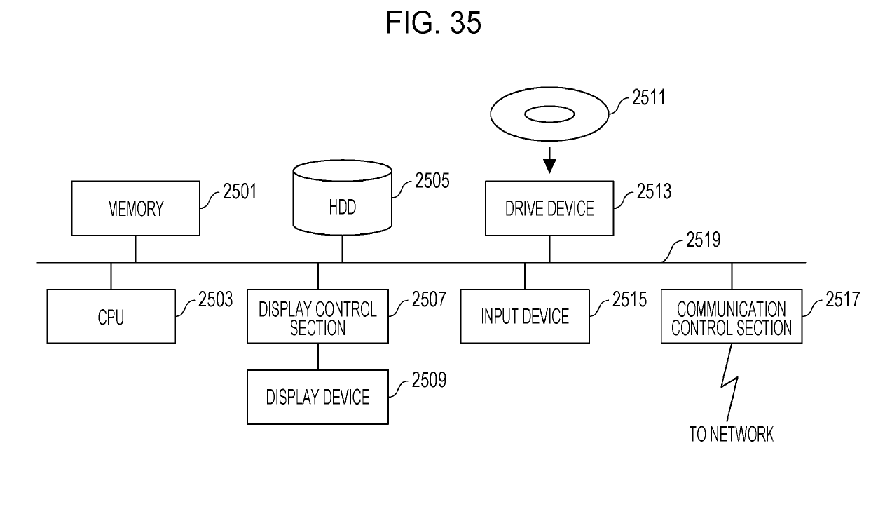

The information processing apparatus 1 described above is a computer apparatus in which, as illustrated in FIG. 35, a memory 2501, a central processing unit (CPU) 2503, a hard disk drive (HDD) 2505, a display control section 2507 coupled to a display device 2509, a drive device 2513 for a removable disk 2511, an input device 2515, and a communication control section 2517 for coupling with a network are coupled to each other via a bus 2519. The operating system (OS) and an application program for executing the processing in this embodiment are stored in the HDD 2505, and are read from the HDD 2505 to the memory 2501 in an event of execution by the CPU 2503. The CPU 2503 controls the display control section 2507, the communication control section 2517, and the drive device 2513 according to the processing contents of the application such that they perform the predetermined operations. Data being processed is mainly stored in the memory 2501, but may be stored in the HDD 2505. In the embodiments of the present disclosure, the application program for executing the processing described above is distributed by being stored in the computer readable removable disk 2511, and installed in the HDD 2505 from the drive device 2513. Also, the application program may be installed into the HDD 2505 via the network such as the Internet and the communication control section 2517. Such a computer apparatus implements various functions such as discussed above by organic collaborations among the hardware such as the CPU 2503 and the memory 2501, and the programs such as the OS and the application program.

The embodiments of the present disclosure discussed above are summarized below.

The information processing apparatus according to an embodiment includes (A) a first generation section (for example, the compile section 102) configured to generate first information including information on a configuration and/or an interface of a first program (for example, a firmware) of an old version based on the code of the first program of the old version, and generate second information including information of the configuration and/or the interface of the first program of a new version based on the code of the first program of the new version, and (B) a second generation section (for example, the first management section 1051 and the second management section 1052) configured to generate information of compatibility between the first program of the old version and the first program of the new version based on whether there is a difference between the first information and the second information generated by the first generation section.

If the configuration or interface is revised, a failure (for example, hang-up) may occur in execution of the program. However, the processing described above makes it possible to check the compatibility.

The code of the first program of the old version may include code for generating the first information, and the code of the first program of the new version may include code for generating the second information. Then, the first generation section may (a1) generate the first information by compiling the code of the first program of the old version, and generate the second information by compiling the code of the first program of the new version. As the first and second information is generated when compiling, determination may be made in a simple manner.

The first information may include information of the number of structures of the first program of the old version, the total size of the structures, and the size of each member, and the number of members of each of the structures, and the second information may include information of the number of structures of the first program of the new version, the total size of the structures, and the size of each member and the number of members of each of the structures. Thus, revision of the configuration may be detected in an appropriate manner.

Also, the first information may include information on the number of interfaces of the first program of the old version, the total size of the interfaces, and the size of each parameter and the number of parameters of each of the interfaces, and the second information may include information on the number of interfaces of the first program of the new version, the total size of the interfaces and the size of each parameter and the number of parameters of each of the interfaces. Thus, revision of an interface may be detected in an appropriate manner.

Also, the first generation section may (a2) generate the second information including information of the interface of the first program of the new version based on the code of the first program of the new version, and may (a2) generate third information including information of an interface of a second program of the new version based on the code of the second program of the new version. Then, the information processing apparatus may further include (C) a third generation section (for example, the third management section 1053) configured to generate information on whether to allow update from the old version to the new version based on whether there is a difference between the second information and the third information. When there is a difference in an interface between programs, communications between the programs may be impossible, and in this case, the updating from the old version to the new version is not to be allowed. Thus, by using the processing discussed above, whether to allow update may be determined from the aspect of the interface between new version programs.

Also, the second information may include information on the number of interfaces of the first program of the new version, the total size of the interfaces and the size of each parameter and the number of parameters of each of the interfaces, and the third information may include information on the number of interfaces of the second program of the new version, the total size of the interfaces, and the size of each parameter and the number of parameters of each of the interfaces. Thus, revision of an interface may be detected in an appropriate manner.

An information processing method according to a second aspect of this embodiment includes (D) generating first information including information of a configuration and/or an interface of a first program of an old version based on code of the first program of the old version, (E) generating second information including information of the configuration and/or the interface of the first program of a new version based on the code of the first program of the new version, and (F) generating information of the compatibility between the first program of the old version and first program of the new version based on whether there is a difference between the generated first information and second information.

A program causing a processor to execute processing according to the above method may be created, and the program may be stored, for example, in a computer readable storage medium or storage device such as a flexible disk, a CD-ROM, an optical magnetic disk, a semiconductor memory, and hard disk. Intermediate processing results may be temporarily stored in a storage device such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and the processor configured to:
generate first information including configuration information and/or interface information of a first program of an old version based on code of the first program of the old version, and generate second information including configuration information and/or interface information of the first program of a new version based on code of the first program of the new version, and
generate information on compatibility between the first program of the old version and the first program of the new version based on whether there is a difference between the first information and the second information generated by the processor.

2. The information processing apparatus according to claim 1, wherein
the code of the first program of the old version includes code for generating the first information,
the code of the first program of the new version includes code for generating the second information, and
the processor generates the first information by compiling the code of the first program of the old version, and generates the second information by compiling the code of the first program of the new version.

3. The information processing apparatus according to claim 1, wherein
the first information includes information on a number of structures of the first program of the old version, a total size of the structures, and a size of each member and a number of members of each of the structures, and
the second information includes information on a number of structures of the first program of the new version, a total size of the structures, and a size of each member and a number of members of each of the structures.

4. The information processing apparatus according to claim 1, wherein
the first information includes information on a number of interfaces of the first program of the old version, a total size of the interfaces, and a size of each parameter and a number of parameters of each of the interfaces, and
the second information includes information on a number of interfaces of the first program of the new version, a total size of the interfaces and a size of each parameter and a number of parameters of each of the interfaces.

5. The information processing apparatus according to claim 1, wherein the processor is configured to:
generate the second information including the information on the interface of the first program of the new version based on the code of the first program of the new version;
generate third information including information on an interface of a second program of the new version based on code of the second program of the new version; and
generate information on whether to allow update from the old version to the new version based on whether there is a difference between the second information and the third information.

6. The information processing apparatus according to claim 5, wherein
the second information includes information on a number of interfaces of the first program of the new version, a total size of the interfaces and a size of each parameter and a number of parameters of each of the interfaces, and
the third information includes information on the number of interfaces of the second program of the new version, the total size of the interfaces, and the size of each parameter and the number of parameters of each of the interfaces.

7. An information processing method executed by a computer, comprising:
generating first information including information on a configuration information and/or an interface of a first program of an old version based on code of the first program of the old version;
generating second information including information on a configuration information and/or an interface of the first program of a new version based on code of the first program of the new version; and
generating information on compatibility between the first program of the old version and the first program of the new version based on whether there is a difference between the generated first information and second information.

8. A non-transitory, computer-readable recording medium having stored therein a program for causing a computer to execute a process, the process comprising:
generating first information including information on a configuration information and/or an interface of the first program of the old version based on code of the first program of the old version;
generating second information including information on a configuration information and/or an interface of the first program of the new version based on code of the first program of the new version; and
generating information on compatibility between the first program of the old version and the first program of the new version based on whether there is a difference between the generated first information and the second information.

9. The information processing apparatus according to claim 1, wherein the interface information is information of a communication command format.

10. The information processing apparatus according to claim 1, wherein the configuration information is information of a data format.
